(19) United States
(12) Patent Application Publication
(10) Pub. No.: US 2023/0367041 A1
(43) Pub. Date: Nov. 16, 2023

(54) REFLECTIVE POLARIZER COATED FRESNEL LENS

(71) Applicant: META PLATFORMS TECHNOLOGIES, LLC, Menlo Park, CA (US)

(72) Inventors: Andrew John Ouderkirk, Kirkland, WA (US); Nagi Hosni Elabbasi, Southborough, MA (US); Liliana Ruiz Diaz, Bothell, WA (US); Sheng Ye, Redmond, WA (US); Ying Geng, Bellevue, WA (US); Christopher Yuan Ting Liao, Seattle, WA (US); Taha Masood, Sammamish, WA (US); Brent Bollman, Seattle, WA (US)

(21) Appl. No.: 17/744,265

(22) Filed: May 13, 2022

(51) Int. Cl. G02B 3/08; G02B 27/01; G02B 27/28; G02B 1/111

(52) U.S. Cl. CPC G02B 3/08; G02B 1/111; G02B 27/0172; G02B 27/283

(57) ABSTRACT

An example apparatus may include a display and an optical configuration configured to provide an image of a display, for example, in a head-mounted device. The optical configuration may include a Fresnel lens assembly including a Fresnel lens and a reflective polarizer. The Fresnel lens may have a structured surface including a plurality of facets, and there may be a step between pairs of neighboring facets. The reflective polarizer may include a plurality of reflective polarizer portions, where each reflective polarizer portion conforms to a corresponding facet of the Fresnel lens. The reflective polarizer may be configured to reflect a first polarization and transmit a second polarization of incident light. The optical configuration may form an image of the display viewable by a user when the user wears the apparatus. Other devices, methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 shows an example optical configuration of a device in accordance with various embodiments.

FIGS. 2A - 2C show a Fresnel lens assembly in accordance with various embodiments.

FIG. 3 shows light propagation through a cross section of an example Fresnel lens assembly in accordance with various embodiments.

FIG. 4 shows a cross section of an example Fresnel lens assembly in accordance with various embodiments.

FIGS. 5 and 6 show cross sections of further example Fresnel lens assemblies in accordance with various embodiments.

FIGS. 7A - 7D illustrate adhesion of a reflective polarizer to one or more facets of a Fresnel lens in accordance with various embodiments.

FIGS. 8A - 8C illustrate a portion of a fabrication apparatus that may be used to fabricate a Fresnel lens assembly in accordance with various embodiments.

FIG. 9 shows a Fresnel lens including linear facets separated by steps in accordance with various embodiments.

FIG. 10 shows a Fresnel lens assembly including a filler layer 1020 that planarizes a faceted surface in accordance with various embodiments.

FIG. 11 shows a Fresnel lens having a curved faceted surface in accordance with various embodiments.

FIG. 12 shows a Fresnel lens assembly having a faceted Fresnel surface and a curved surface in accordance with various embodiments.

FIG. 13 illustrates a device including a display and an optical configuration that includes a Fresnel lens assembly in accordance with various embodiments.

FIG. 14 shows a reflective polarizer layer having both internal and external faceted surface profiles in accordance with various embodiments.

FIG. 15 illustrates an optical configuration in accordance with various embodiments.

FIG. 16 illustrates an optical configuration and possible light ray trajectories in accordance with various embodiments.

FIGS. 17 - 19 show example methods of fabricating a Fresnel lens assembly in accordance with various embodiments.

FIG. 20 shows an example method of operation of a Fresnel lens assembly in accordance with various embodiments.

FIG. 21 is an illustration of exemplary augmented-reality glasses that may be used in connection with embodiments of this disclosure.

FIG. 22 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and is described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to optical configurations, devices including optical configurations, and associated methods or apparatus. As is explained in greater detail below, embodiments of the present disclosure may include a Fresnel lens assembly suitable for virtual and/or augmented reality systems. A Fresnel lens assembly may include a reflective polarizer and a Fresnel lens.

An example apparatus may include an optical configuration including a Fresnel lens assembly. An example Fresnel lens assembly may include a reflective polarizer, for example, configured to reflect a first polarization of light and transmit a second polarization of light. For example, a reflective polarizer may reflect one handedness of circular polarized light and transmit the other handedness of circularly polarized light. Example apparatus may include a beamsplitter lens or, in some examples, a second Fresnel lens assembly. A beamsplitter lens may include a beamsplitter formed as a coating on a lens.

Example reflective polarizers include, without limitation, cholesteric reflective polarizers (CLCs) and/or multilayer birefringent reflective polarizers. Other examples are discussed below.

Examples include an apparatus including a folded optic configuration, such as an apparatus including a Fresnel lens assembly. Use of a Fresnel lens assembly may allow an increased optical efficiency of an optical configuration, for example, by reducing losses associated with beamsplitters. Increased optical efficiency may provide one or more of the following aspects: improved image appearance (e.g., improved image brightness, uniformity and/or resolution), increased lens efficiency, reduced power consumption, and/or reduced heat generation for a given brightness. Examples also include associated methods, such as methods of fabrication of improved Fresnel lens assemblies, methods of fabricating devices including one or more Fresnel lens assemblies, or methods of device use.

Example devices may include a Fresnel lens assembly including a polarized reflector configured to reflect a first light polarization and transmit a second light polarization. In some examples, a Fresnel lens assembly may include a Fresnel lens having at least one faceted surface and a reflective polarizer. The reflective polarizer may include a layer located on one or more facets of the Fresnel facets. At least one surface of a Fresnel lens may include a plurality of facets with adjacent facets separated by a step (sometimes termed a riser). A reflective polarizer may include a layer disposed adjacent to the Fresnel lens, for example, supported by the facets. The reflective polarizer may conform to at least a portion of at least one of the facets. An example Fresnel lens may include an optical material, such as a glass or an optical polymer. An example Fresnel lens may be generally transparent for some or all visible wavelengths.

In some examples, all portions of the reflective polarizer (e.g., supported by facets of a Fresnel lens) may have similar configurations and/or optical properties. In some examples, a Fresnel lens assembly may include reflective polarizer portions having different refractive index values and/or optical dispersion properties. For example, different reflective polarizer portions may include different polymers. The optical properties of the reflective polarizer portions may be configured to improve the wavelength independence of the Fresnel lens assembly properties. In some examples, the Fresnel lens assembly may be configured as an achromatic lens using suitably configured reflective polarizer portions.

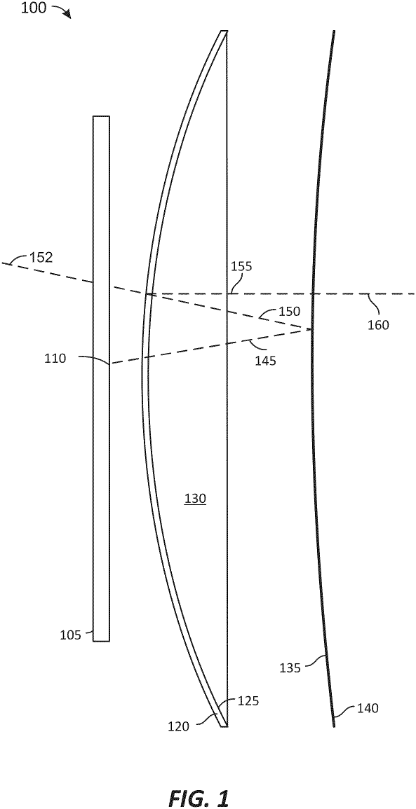

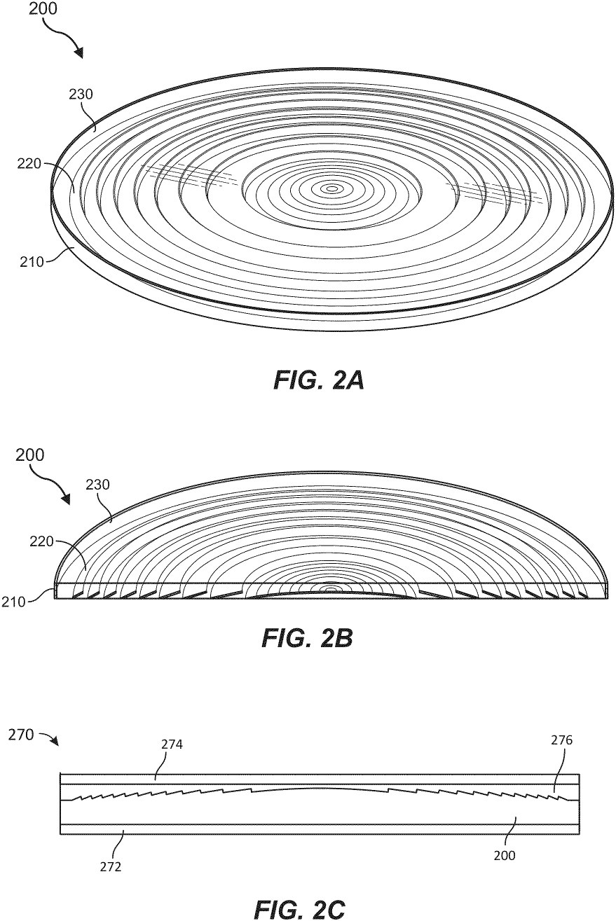

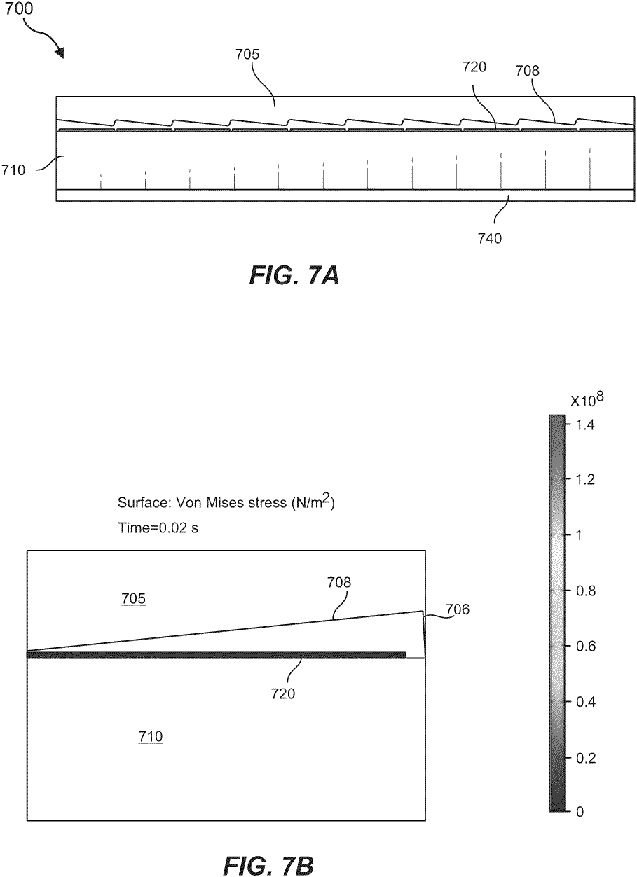

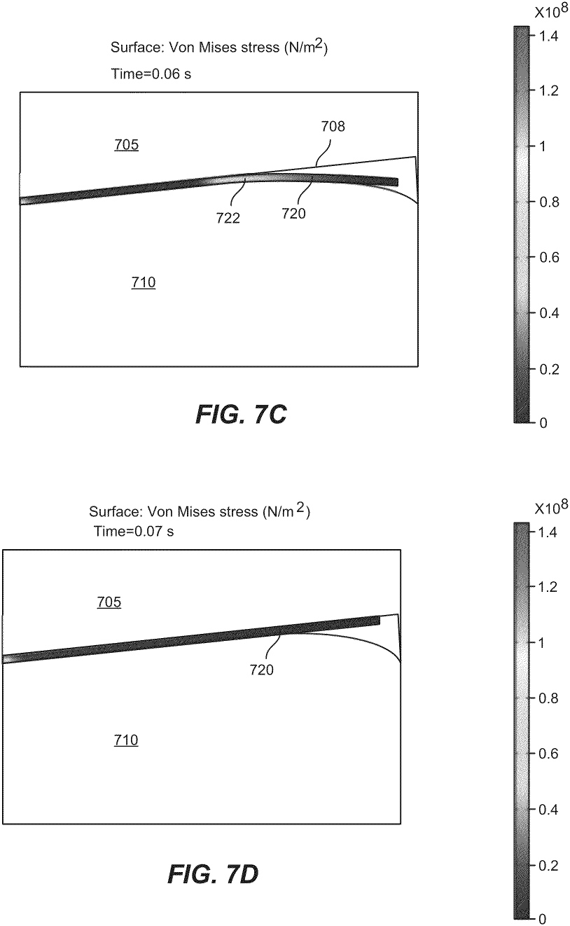

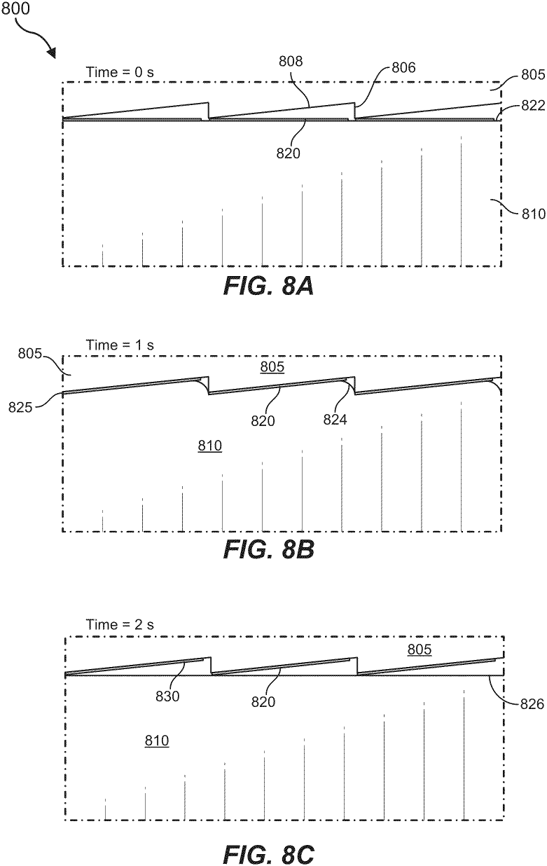

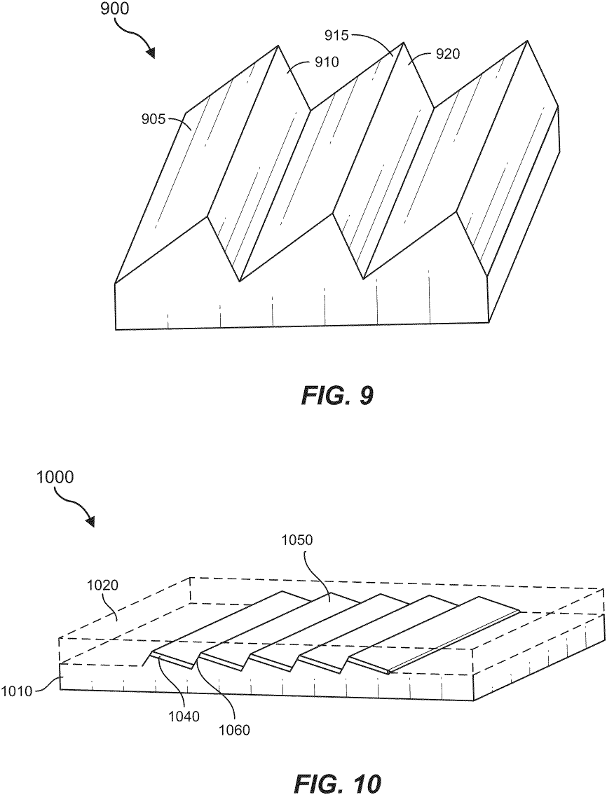

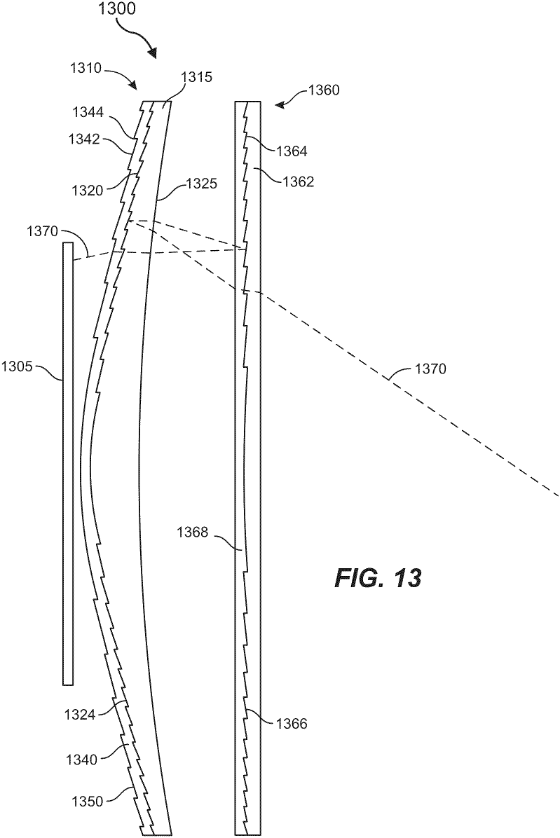

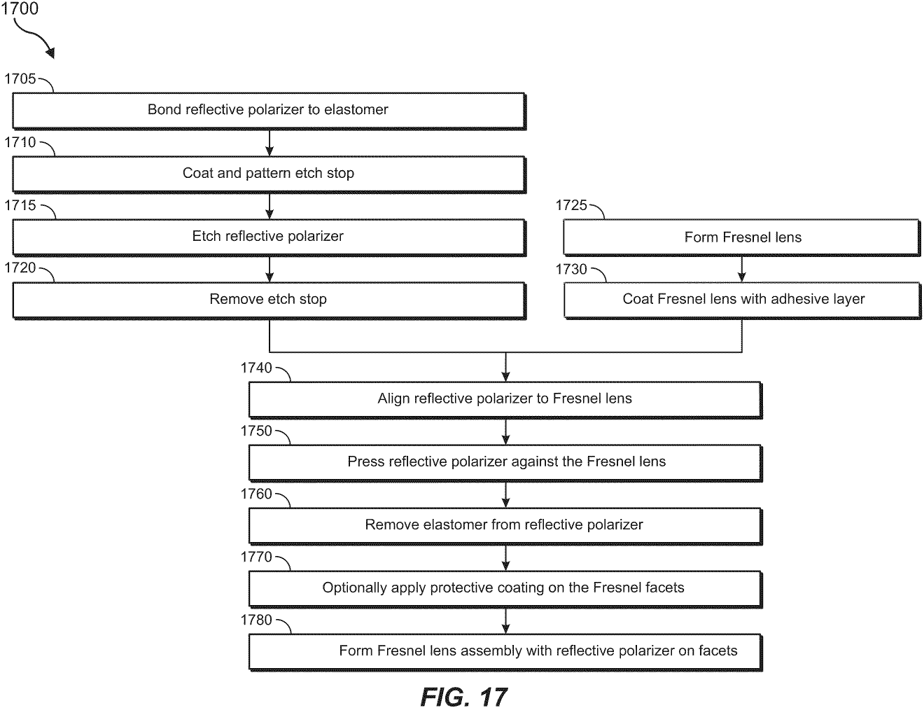

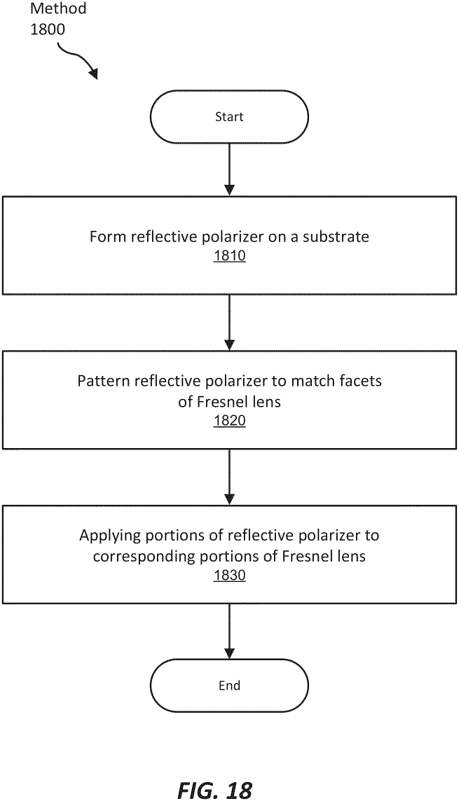

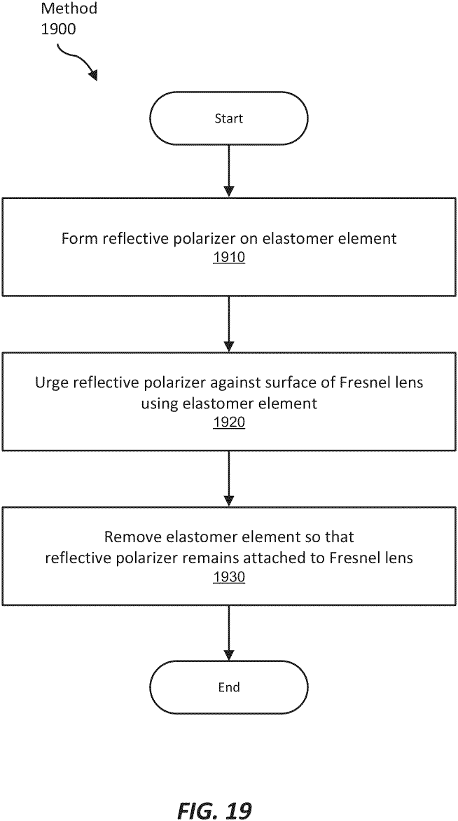

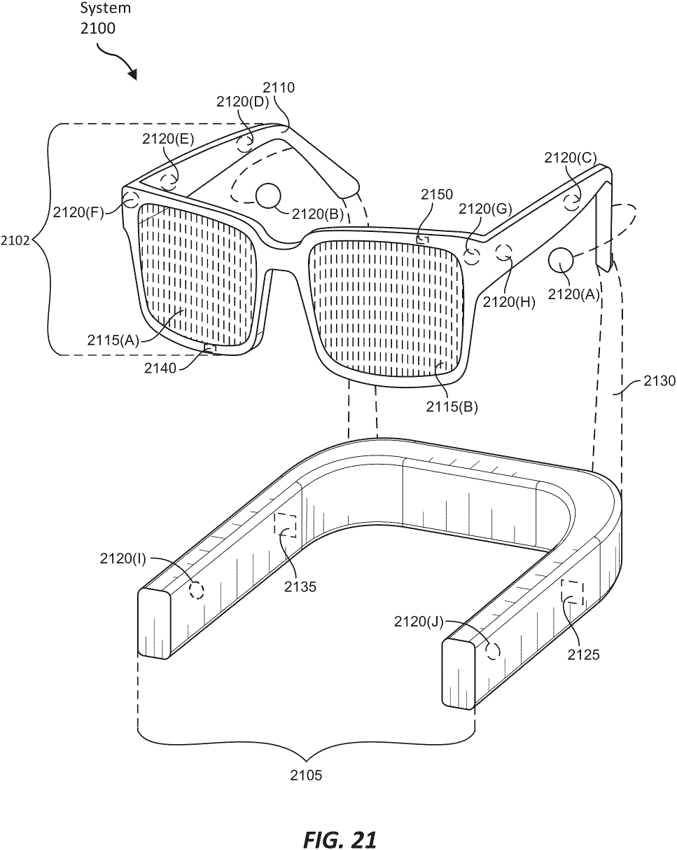

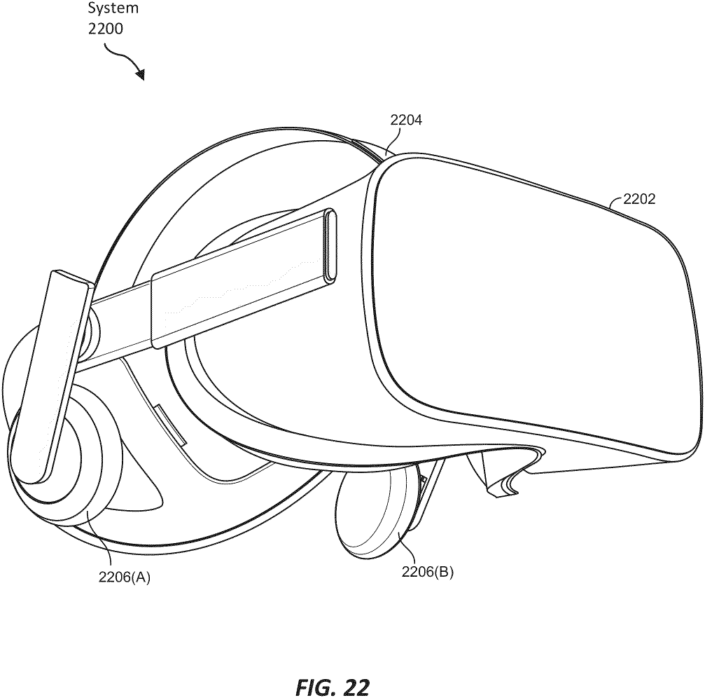

The following provides, with reference to FIGS. 1-22, detailed descriptions of example embodiments. FIG. 1 shows an example optical configuration. FIGS. 2-6 show example Fresnel lens assemblies, display and imaging systems, and example ray paths. FIGS. 7A-8C illustrate example device fabrication apparatus. FIGS. 9-12 illustrate further example Fresnel lenses and Fresnel lens assemblies including a reflective polarizer. FIGS. 13-16 show further example Fresnel lens assemblies and optical configurations. FIGS. 17-20 illustrate example methods of device fabrication and operation. FIGS. 21-22 illustrate example augmented reality and virtual reality systems.

In some examples, a Fresnel lens may have a reflective polarizer formed as a layer on at least one of the Fresnel lens facets. The layer may include a multilayer optical film, cholesteric liquid crystal, or an arrangement of anisotropic conductors such as a nanowire arrangement. The facets and coating may be embedded in a filler layer that may include an optically clear polymer. In some examples, a filler layer may planarize or otherwise smooth an exterior surface of a Fresnel lens assembly. The refractive indices and optical dispersions of the Fresnel lens material and the filler polymer may be configured to reduce chromatic aberration (e.g., to reduce visually discernable colored fringes in an image of the display). In some examples, the filler polymer may be configured as a second Fresnel lens, a geometric lens, and/or diffractive lens. For example, the filler polymer may have a first surface having facets forming an interface with the first Fresnel lens, and a second surface such as a non-faceted surface (e.g., a planar surface or a curved surface such as a concave, convex, aspheric or freeform surface) or a faceted surface. In some examples, the filler polymer may form a diffractive lens including diffractive elements on one or both surfaces. In some examples, a reflector or reflective polarizer may be located between the facets of the first Fresnel lens and the filler polymer.

Optical materials may be selected to provide low birefringence (e.g., less than one quarter wavelength optical retardance, such as less than approximately λ/10, for example, less than approximately λ/20). In some examples, a Fresnel lens and/or filler polymer (and/or other optical element) may include a silicone polymer such as polydimethylsiloxane (PDMS), cyclic olefin polymer (COP), cyclic olefin copolymer (COC), polyacrylate, polyurethane, polycarbonate, or other polymer. For example, a silicone polymer (e.g., PDMS) Fresnel lens may be supported on a rigid substrate such as glass or a polymer (e.g., a relatively rigid polymer compared with the silicone polymer).

Vapor deposition of coatings may lead to unwanted deposition on the steps (sometimes termed risers) between facets. Deposition on steps may be difficult to control and may lead to visually discernable visible imperfections. Appropriately patterned reflective polarizer portions may be selectively located on the facets of a Fresnel lens. In some examples, the reflective polarizer portions may be supported on an elastomeric element.

Fresnel lens assemblies including a reflective polarizer may be used in augmented reality and/or virtual reality (AR/VR) systems. In some examples, a Fresnel lens assembly may include a Fresnel lens and at least one other optical component, such as one or more of a reflective polarizer, an optical filter, an absorbing polarizer, a diffractive element, an additional refractive element, a reflector, an antireflection film, a mechanically protective film (e.g., a scratch-resistant film), or other optical component. An apparatus including a Fresnel lens assembly may further include a display and a beamsplitter.

In some examples, an AR/VR system may include a Fresnel lens assembly including a Fresnel lens and a polarized reflector. The optical properties of the Fresnel lens may be optimized individually, but in some examples, the properties of a reflective polarizer, filler layer, or other layer may be configured to improve the Fresnel lens performance (e.g., by reducing chromatic aberration). In some examples, a Fresnel lens may be concave, convex, or may have a complex optical profile such as a freeform surface. For example, the structured surface of a Fresnel lens may include facets corresponding to portions of a freeform lens optical surface, or of other lens surfaces such as other concave or convex surfaces.

The wavelength-dependent properties of a Fresnel lens assembly, or polarized reflector, may be adjusted by, for example, adjusting one or more parameters of a multilayer film configuration (e.g., individual layer refractive indices, optical dispersion, and/or layer thicknesses). In some examples, a reflective polarizer may have a particular bandwidth of operation and the bandwidth of operation may be adjusted using one or more parameters of one or more components (e.g., refractive index, optical dispersion, layer thickness, and the like).

Applications of Fresnel lens assemblies may include use in the optical configuration of a wearable device (e.g., a head-mounted device), for example, use of one or more Fresnel lens assemblies in an optical configuration configured to form an image of a display viewable by a user when the user wears the wearable device. Other example applications may include IR (infra-red) rejection in, for example, imaging, display, projection, or photovoltaic systems. Applications may include wavelength selection for optical waveguides, for example, to select red, green, yellow, and/or blue wavelengths for transmission along a waveguide using a Fresnel lens assembly at the waveguide input. In some examples, a structured surface may be formed at the light entrance to any suitable optical component and configured as a Fresnel lens assembly.

FIG. 1 shows an optical configuration 100 including a display 105, beamsplitter 120, lens 130 and a polarized reflector 140. Light beams emitted by the display are shown as dashed lines. A light ray 145 is emitted by a display portion 110 of display 105, passes through the beamsplitter 120 and lens 130, and is reflected back as ray 150 from the polarized reflector 140. Refraction at the lens surfaces is not shown for illustrative convenience. The ray 150 is then reflected by the beamsplitter to give ray 155 which passes through the polarized reflector and is directed towards the eye of a user as ray 160. Stray light beams such as light beam 152 may reduce the beam intensity that reaches the eye of a user. The eye of a user is not shown, but a viewing location such as an eyebox may be located to the right of the optical configuration as illustrated. In some examples, the beamsplitter 120 may be formed as a partially reflective film (e.g., a thin metal film) on the convex lens surface 125 of the lens 130. In some examples, the optical configuration may further include an optical retarder which may, for example, be included as a layer formed on surface 135 of the polarized reflector 140.

Improvements in the optical configuration 100 may be desirable, such as reduced weight and power consumption in device applications. In some examples, the lens 130 may be a Fresnel lens. In some examples, the polarized reflector may be part of a Fresnel lens assembly. In some examples, the beamsplitter may be replaced by a polarized reflector to reduce losses associated with the beamsplitter.

A Fresnel lens may effectively divide a curved surface of a refractive lens (e.g., shown as convex lens surface 125 in FIG. 1) into facets. The facets may include curved portions (or planar approximations thereof) that approximate respective portions of the convex surface. There may be steps between the facets that allow the thickness of a Fresnel lens to be significantly less than that of a traditional convex lens. Fresnel lenses are discussed in more detail below.

FIG. 2A shows a Fresnel lens assembly 200 including a Fresnel lens 210 and a reflective polarizer 220. In this example, the facets of the Fresnel lens 210 are coated with the reflective polarizer 220. The Fresnel lens assembly may function as reflective polarizing Fresnel lens.

FIG. 2B shows a sectional view of the Fresnel lens assembly 200 including the Fresnel lens 210. The facets of the Fresnel lens 210 support a layer that forms the reflective polarizer 220. In this example, the faceted side of the Fresnel lens is planarized using a filler layer 230. The filler layer may include an optically transparent material such as glass or an optical polymer. The filler layer may include air, a liquid, polymer, glass, ceramic, or a combination thereof.

In some examples, the filler layer may include one or more polymers, such as a polyethylene, a cyclic polyolefin (COP), an acrylate polymer (e.g., polymethylmethacrylate, PMMA), a silicone polymer (e.g., polydimethylsiloxane, PDMS), a urethane polymer, a polycarbonate, a polyethylene, a polyethylene naphthalate, a polyethylene terephthalate, a polystyrene, and the like, and/or combinations, derivatives or blends thereof. In some examples, an example filler layer may include a gel or a low modulus polymer such as low molecular weight PDMS, or an oligomer such as a silicone oil. In some examples, a portion (e.g., one or more layers of another optical element such as a reflective polarizer) may include one or more polymers such as the polymers mentioned herein.

FIG. 2C shows an optical assembly 270 that includes a Fresnel lens assembly 200 (e.g., including a reflective polarizer) located at least in part between first and second substrates which may, for example, include a glass or a polymer. The first substrate 272 may support the Fresnel lens assembly. The second substrate 274 may provide mechanical protection for the upper surface profile of the Fresnel lens assembly. A gap 276 between the profiled substrate and the second substrate may include the filler layer. The filler layer may include a gas (e.g., air, nitrogen, a rare gas such as argon, or other gas that is non-reactive with the optical material), a liquid, or a solid. In some examples, a solid filler layer may also provide the second substrate so that a separate second substrate may be omitted. In some examples, the filler layer has an appreciably different refractive index (e.g., substantially lower than) the refractive index of the optical material used to fabricate the Fresnel lens. In some examples, the second substrate or the first substrate may include a reflective polarizer. In some examples, the faceted surface of a Fresnel lens may be planarized using a filler layer and a reflective polarizer may be located on the filler layer.

In some examples, the Fresnel lens and the filler layer include the same material. In some examples, the Fresnel lens and the filler layer may have a matched refractive index for at least one wavelength (e.g., of visible light), but the two materials may have different optical dispersions. In some examples, the Fresnel lens and the filler layer may have substantially different refractive indices. For example, the refractive index of the filler layer may differ by at least approximately 0.1, 0.2, 0.5 or more from that of the Fresnel lens.

In some examples, at least one of the Fresnel lens and filler layer may have a low value of birefringence, and may have an optical retardance for at least one wavelength of visible light that is less than ¼ wave, such as less than ⅛th wave, and in some examples, less than 1/16th wave.

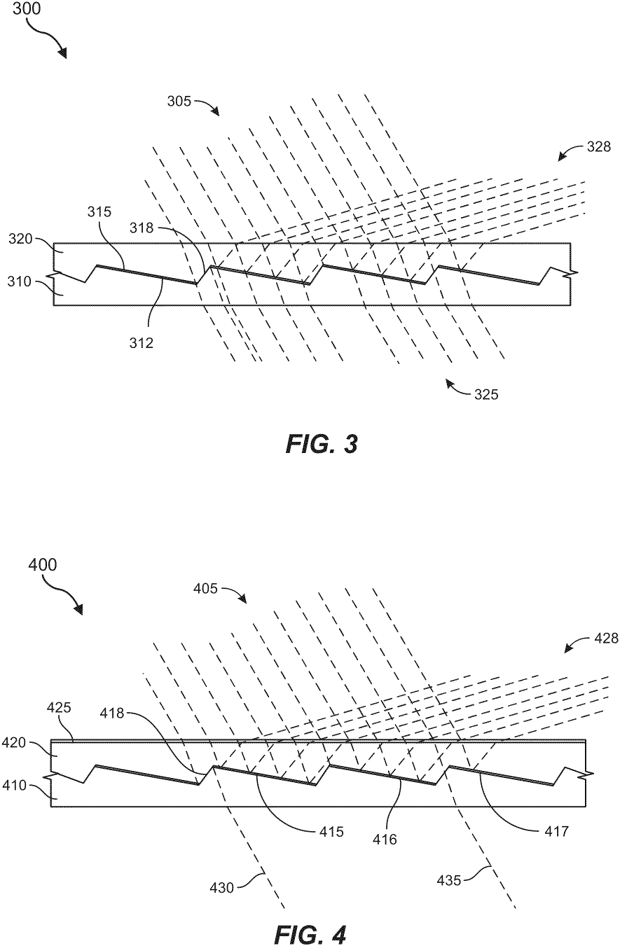

FIG. 3 shows possible light propagation through a cross section of an example Fresnel lens assembly 300. The Fresnel lens assembly 300 includes a Fresnel lens 310, a reflective polarizer 315, and a filler layer 320. The facets 312 of the Fresnel lens 310 support the reflective polarizer 315, denoted in the figure by a thick line. Adjacent facets 312 are separated by steps 318. The reflective polarizer is configured to reflect a first polarization of light and transmit a second polarization of light. A light ray bundle 305 may include light having the first polarization that is reflected by the reflective polarizer 315 to form reflected ray bundle 328, and may include light of the second polarization that is transmitted by the reflective polarizer to form transmitted ray bundle 325.

FIG. 4 shows a cross section of an example Fresnel lens assembly 400 including a Fresnel lens 410, reflective polarizers 415, 416, 417, a filler layer 420, and an absorbing polarizer 425. Incident light rays are shown as ray bundle 405 and reflected light rays are shown as ray bundle 428. The absorbing polarizer 425 may transmit a first polarization of light that is reflected by reflective polarizers 415, 416 and 417. The absorbing polarizer may absorb a second polarization of light that would otherwise be transmitted by the reflective polarizers 415, 416, 417. A step 418 may be located between adjacent reflective polarizer facets. In some examples, a reflective layer (e.g., a metal film) may be used in place of the reflective polarizers. Stray light rays (such as rays 430 and 435) may be transmitted through the Fresnel lens assembly. In some examples, stray light rays may pass through a gap between reflective polarizers, such as through the gap between reflective polarizers 416 and 417. Stray light rays may arise due to multiple reflections off the reflective polarizers and/or other interfaces.

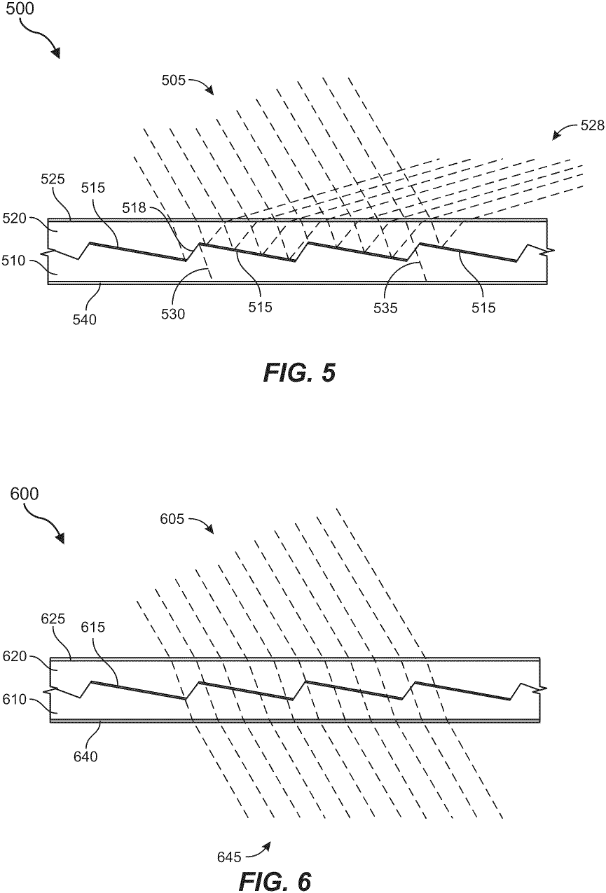

FIG. 5 shows a cross section of an example Fresnel lens assembly 500 including Fresnel lens 510, reflective polarizer 515 located on a facet of the Fresnel lens 510, filler layer 520, absorbing polarizer 525, and second absorbing polarizer 540. A step 518 may be located between adjacent facets. Incident light rays are shown as ray bundle 505 and reflected light rays are shown as ray bundle 528. The Fresnel lens assembly 500 may function in a similar manner to the Fresnel lens assembly 400 described above in relation to FIG. 4. The second absorbing polarizer 540 may absorb stray light rays such as rays 530 and 535.

FIG. 6 shows a cross section of an example Fresnel lens assembly 600 including Fresnel lens 610, reflective polarizer 615 located on a facet of the Fresnel lens 610, filler layer 620, first polarizer 625 and second polarizer 640. In this example, a ray bundle 605 may be polarized (or further polarized) by first polarizer 625. Ray bundle 605 may have a polarization state that is preferentially transmitted by the reflective polarizer 615. Second polarizer 640 may be configured to preferentially transmit ray bundle 605 to form ray bundle 645.

FIGS. 7A - 7D illustrate adhesion of a reflective polarizer to one or more facets of a Fresnel lens.

FIG. 7A illustrates a fabrication apparatus 700 including a Fresnel lens 705 having facets 708. A reflective polarizer 720 is supported by an elastomer element 710. The reflective polarizer is divided into portions that are sized to correspond to the facets 708. The elastomer element 710 is supported by a substrate 740 which may include a rigid element such as a plate. The elastomer element 710 may be urged towards the Fresnel lens 705 allowing portions of the reflective polarizer 720 to be adhered to corresponding facets 708 of the Fresnel lens 705. In some examples, the substrate 740 may be attached to or otherwise in mechanical communication with at least one actuator configured to urge the elastomer element against one or more facets of the Fresnel lens on receipt of an appropriate control signal from a controller.

Simulations showed that the reflective polarizer could be adhered to the facets 708 without excessive stress developing in the reflective polarizer. The von Mises stress within the reflective polarizer during attachment to the Fresnel lens facets are indicated in grayscale in terms of units of 10⁸ N/m². The stress may be adjusted by adjusting one or more parameters such as the stiffness of the substrate, the stiffness of the elastomer, the speed of deposition, provision of a compressible adhesive layer, and the like.

FIG. 7B shows a portion of the fabrication apparatus 700 showing the elastomer element 710, the reflective polarizer 720, and the Fresnel lens 705. Only a representative facet (of the facets 708) of the Fresnel lens 705 is shown, along with part of a step 706 separating adjacent facets. Initially, the stress in the reflective polarizer may be approximately zero as the reflective polarizer is supported by a surface of the elastomer element 710. In some examples, a portion of the reflective polarizer 720 may be sized to cover at least part or essentially all of a corresponding facet of the facets 708, and may not cover the step 706.

FIG. 7C shows a portion of the reflective polarizer 720 urged against the facet 708 of the Fresnel lens 705 by an upwards (as illustrated) force applied to the elastomer element 710. There is some stress in a region 722 of the reflective polarizer 720 where the reflective polarizer is effectively in process of being transferred from the elastomer element 710 to a facet 708 of the Fresnel lens 705. However, the stress may be insufficient to induce any damage to the reflective polarizer.

FIG. 7D shows the reflective polarizer 720 fully attached to a facet of the Fresnel lens 705 as the elastomer element 710 is moved upward further than in FIG. 7C. The stresses in the reflective polarizer are very low at this forming stage. The elastomer element 710 may have a surface coating that facilitates release of the reflective polarizer from the elastomer element 710. The facet may have surface coating that promotes adhesion of the reflective polarizer to the facet of the Fresnel lens 705.

FIGS. 8A - 8C further illustrate part of a fabrication apparatus 800 that may be used to fabricate a device according to some embodiments.

FIG. 8A shows an approach to depositing a reflective polarizer onto the facets of a Fresnel lens. The figure shows part of a fabrication apparatus 800, showing parts of a Fresnel lens 805 having a facet 808, step 806, an elastomer element 810, and a reflective polarizer 820. Portions 822 of reflective polarizer 820 are shown supported by elastomer element 810. The reflective polarizer 820 may be patterned into portions that are sized to match and/or conform to the facets 808 before or after the reflective polarizer is deposited on the elastomer element 810.

FIG. 8B shows the elastomer element 810 moved towards the Fresnel lens, for example, using an actuator. The reflective polarizer 820, such as reflector polarizer portion 825, is in contact with the facets of the Fresnel lens 805. The upper surface of the elastomer element may include portions 824 that do not make contact with the Fresnel lens. However, the reflective polarizer may be attached to the Fresnel lens using this approach.

FIG. 8C shows the elastomer element moved away from the Fresnel lens. The reflective polarizer is released from the upper surface 826 of the elastomer element 810 and is attached to the facets of the Fresnel lens 805. The reflective polarizer 820 may include different portions (e.g., portion 830) that may have the same or different compositions.

The times shown in FIGS. 7A - 7D and FIGS. 8A - 8C may correspond to particular times during an example method of attaching reflective polarizer portions to Fresnel lens facets. A time of zero may correspond to a start of a process, for example, initiating a movement of a substrate such as an elastomer element towards the Fresnel lens, or initiating a simulation of substrate movement. The indicated times are exemplary and not limiting.

The elastomer element used to support the reflective polarizer during fabrication may include a natural rubber, silicone elastomer, thermoplastic elastomer, polydimethylsiloxane (PDMS), or other type of elastomers. The elastomer element may include by any another soft material and/or structure that can undergo large deformation, such as a structure including a fluid filled enclosure at least partially defined by a flexible membrane. In some examples, the polarizer may be supported by the flexible membrane. Fluid pressure may be adjusted (e.g., increased) to urge the membrane against the Fresnel lens to adhere the polarizer to the facets of the Fresnel lens. In some examples, a flexible membrane, spring, or other elastic element may be used to urge an elastomer element or other structure supporting the polarizer against the Fresnel lens. For example, the polarizer may be supported by a polymer film.

In some examples, a reflective polarizer supported by an elastomer element may be divided into portions that are in register with and sized to conform to corresponding facets of a Fresnel lens. In some examples, the different portions of the reflective polarizer may have the same composition and/or may have similar optical properties. In some examples, the different portions of the reflective polarizer may have different optical properties and, for example, may have different compositions. For example, different portions of the reflective polarizer may include different polymers. Different portions of the reflective polarizer may have different optical properties, for example, different refractive index at a given wavelength and/or different optical dispersion. In some examples, a Fresnel lens may be configured as an achromatic lens and have reflective polarizer portions having different optical properties.

In some examples, a reflective polarizer may include portions sized to conform to the facets of a Fresnel lens. A Fresnel lens may have circular, ring-shaped, linear, or cylindrical facets.

FIG. 9 shows a Fresnel lens 900 including facets (e.g., facets 905 and 915) and steps (e.g., steps 910 and 920). In this example, the Fresnel lens has generally linear facets. In some examples, the facets may include circular facets or other facet shapes, such as oval, elliptical, annular, linear (e.g., rectangular), and the like.

FIG. 10 shows a Fresnel lens assembly 1000 including a Fresnel lens 1010, a filler layer 1020 that planarizes the upper surface of the Fresnel lens assembly 1000, and reflective polarizer portions 1040 and 1050 disposed on the facets of the Fresnel lens 1010. In this example, the reflective polarizer portions may be generally rectangular. However, reflective polarizer portions sized to cover corresponding facets of a Fresnel lens may be any appropriate shape. A step 1060 may be located between adjacent reflective polarizer portions 1040 and 1050, and the step may not support a reflective polarizer portion.

In some examples, a Fresnel lens assembly may include a Fresnel lens, having a faceted surface and a non-faceted surface, and a reflective polarizer located on the non-faceted surface (e.g., a reflective polarizer located on a planar, concave or convex surface of a Fresnel lens). In some examples, the faceted surface may be smoothed out (e.g., planarized) using a filler layer and the reflective polarizer may be located on the filler layer. In some examples, the filler layer may have a first surface that conforms to the faceted surface of a Fresnel lens and a second surface that is a planar surface or a non-faceted (smooth) curved surface such as a concave or convex surface. In some examples, the reflective polarizer may be located on the second surface of the filler layer. In some examples, the reflective polarizer may be located on the facets of the Fresnel lens and a filler layer may be located over the reflective polarizer and Fresnel lens and may act as a protective layer. In some examples, a Fresnel lens assembly may include one or more antireflection coatings on faceted and/or non-faceted surfaces. In some examples, a reflective polarizer may be applied to the non-faceted surface, instead of or additional to application to the faceted surface. In some examples, a Fresnel lens may have two faceted surfaces and the reflective polarizer may be applied to at least one of the two faceted surfaces.

In some examples, a Fresnel lens assembly may include a Fresnel lens such as those shown in FIGS. 9 and 10, having a reflective polarizer formed on at least one facet. An example Fresnel lens assembly may be used in combination with a photovoltaic device such as a solar cell to improve photovoltaic efficiency. In some examples, a Fresnel lens assembly may be configured to transmit visible light (e.g., to a photovoltaic device) and reflect IR radiation (e.g., to reduce heating of a photovoltaic device). For example, a Fresnel lens assembly may include a dichroic filter and/or a reflector (e.g., a reflective polarizer) may be configured to selectively reflect IR radiation or other wavelength ranges (e.g., red and/or near-IR, or other wavelength range).

An example Fresnel lens may also include a peripheral edge but for lens applications the edge may not be useful as a light receiving surface, and may be coated with a light absorbent coating.

In some examples, a Fresnel lens assembly may include a waveguide having at least a portion of a surface including facets and steps, and at least one waveguide edge may be used as a light receiving or light transmitting surface.

A Fresnel lens assembly may include a Fresnel lens having a planar surface and an opposed surface including facets and steps. In some examples, a Fresnel lens may include a curved surface without facets, such as a convex or concave surface. In some examples, a Fresnel lens may include a curved surface having facets and steps. The steps may allow a reduction in lens thickness and/or an increase in lens optical power for a given lens thickness.

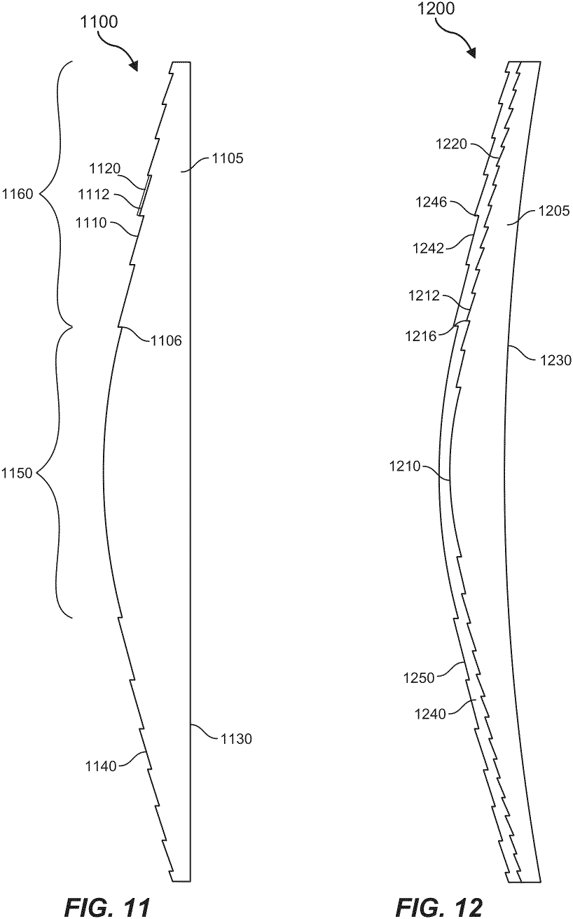

FIG. 11 shows a Fresnel lens 1100 having a lens body 1105 having a planar surface 1130 and a curved surface 1140 including facets (e.g., facets 1110 and 1112) and steps (e.g., steps 1106). A step may be located between adjacent facets. In some examples, a reflective polarizer may be applied to one or more facets. The figure shows only a portion of reflective polarizer 1120 located on facet 1112, but other facets may also support portions of the reflective polarizer. The Fresnel lens 1100 may be circular (the figure showing a cross-section) and may have a central region including a circular central facet 1150 surrounded by a peripheral region 1160 including encircling concentric ring-shaped facets. In some examples, the curved surface 1140 may be an aspheric conic surface, and the central facet 1150 may include a relatively large spherical or aspherical surface, and the peripheral region 1160 may include concentric ring-shaped facets. A reflective polarizer layer is applied to some or all of the curved surface 1140. The curved surface 1140 may support additional coatings, for example, a partially or highly reflective metal coating, an absorbing or reflective polarizer, an antireflective coating, or a combination thereof.

A Fresnel lens assembly may include a Fresnel lens and a reflective polarizer that covers both the facets and steps of the Fresnel lens. In some examples, the reflective polarizer may have a first surface that conforms to the facets and steps of the Fresnel lens and a second surface that may be a flat, spherical, cylindrical, aspherical, conic, aspheric conic, other Zernike shaped surface or a combination thereof. The second surface of the reflective polarizer may support another layer such as an anti-reflectance or scratch-resistant layer or may be an exterior surface of the assembly. A surface of a Fresnel lens and/or a reflective polarizer may include a diffractive volume Bragg or surface relief grating, and/or other optical element. The surface and/or layer configuration of an example Fresnel lens and/or reflective polarizer may be flat, spherical, cylindrical, aspherical, Fresnel, other Zernike shape, or a combination thereof.

FIG. 12 shows a Fresnel lens assembly 1200 including a Fresnel lens 1205 having a curved surface 1230 and a surface 1210 that includes facets and steps, such as facet 1212 and step 1216. A reflective polarizer 1220 may be located on and conform to the facets of the surface 1210. A filler polymer layer 1240 may be located on the reflective polarizer. In this example, the surface 1250 of the filler polymer layer 1240 may include facets and steps, such as facet 1242 and step 1246. The curved surface 1230 may be a concave surface (e.g., a concave spherical, parabolic, conic, or aspheric conic surface), or in other examples may be planar or convex. The figure illustrates that the steps in the surface 1210 of the Fresnel lens 1205 need not be in register with the steps 1246 in the exterior surface of the filler polymer layer. In some examples, an exterior surface may be adjacent to air. In some examples, including offsets between steps in different layers may reduce the user perception of the steps.

FIG. 13 illustrates a display 1305 and an optical configuration 1300 that may be configured to receive light from the display and direct the light to a target location. The target location may be the eyebox of a head-mounted device and may allow viewing of the display through the optical configuration when the eye of a user is located within the eyebox. The optical configuration includes a first Fresnel lens assembly 1310 and a second Fresnel lens assembly 1360.

The first Fresnel lens assembly 1310 may include a Fresnel lens 1315 (having a faceted surface 1324 and a concave surface 1325) and a reflective polarizer 1320 located on the faceted surface 1324 of the Fresnel lens 1315. The reflective polarizer 1320 may conform to the faceted surface of the Fresnel lens. A filler polymer layer 1340 may have an exterior structured surface 1350 (facing the display) that is also faceted, and the interior surface may be structured to complement the structured surface of the Fresnel lens. The facets 1342 of the exterior surface 1350 of the filler polymer layer 1340 may be wider than facets of the faceted surface 1324 of the Fresnel lens 1315 (e.g., when comparing facets having an approximately similar average radial distance from an optical center of the lens). In some examples, the exterior surface 1350 of the filler polymer layer may be a smooth curve, or facets having a similar size as the facets of the Fresnel lens. In some examples, the steps of different faceted surfaces may be offset (e.g., may have a different average radius relative to the optical center or axis of the lens). For example, the step 1344 in the exterior surface 1350 of the filler polymer layer 1340 may not be in register with a step in the structured surface 1324 of the Fresnel lens 1315.

The second Fresnel lens assembly 1360 may include a Fresnel lens 1362 and a reflective polarizer 1364, located on the facets of a structured surface 1366 of the Fresnel lens 1362. The second Fresnel lens assembly 1360 further includes filler polymer layer 1368 that has a planar exterior surface and facets and steps approximately complementary to the structured surface of the Fresnel lens 1362.

An example light beam 1370 is shown emitted from the display 1305 as a dashed line. The light beam 1370 passes through the first Fresnel lens assembly 1310 and is reflected back by the second Fresnel lens assembly 1360. In some examples, an illustrated polarized reflector may be replaced by a reflector and/or beamsplitter. The light beam may be reflected from a reflector (e.g., beamsplitters) or a polarized reflector within each of the Fresnel lens assemblies. The light beam is reflected back by the first Fresnel lens assembly 1310 and is transmitted through the second Fresnel lens assembly 1360. The light beam may then emerge from the optical configuration 1300 directed towards the eye of a user (not shown, but which may be located towards the right of the optical configuration).

In some examples, the polarized reflector may be located between the Fresnel lens and the filler polymer layer (if present), and in some examples, the reflective polarizer may be located only on the facets of the Fresnel lens and not on the steps. In some examples, the relative positions of the Fresnel lens, the reflective polarizer, and the filler polymer layer (if present) within a Fresnel lens assembly as described herein may be reversed or otherwise rearranged.

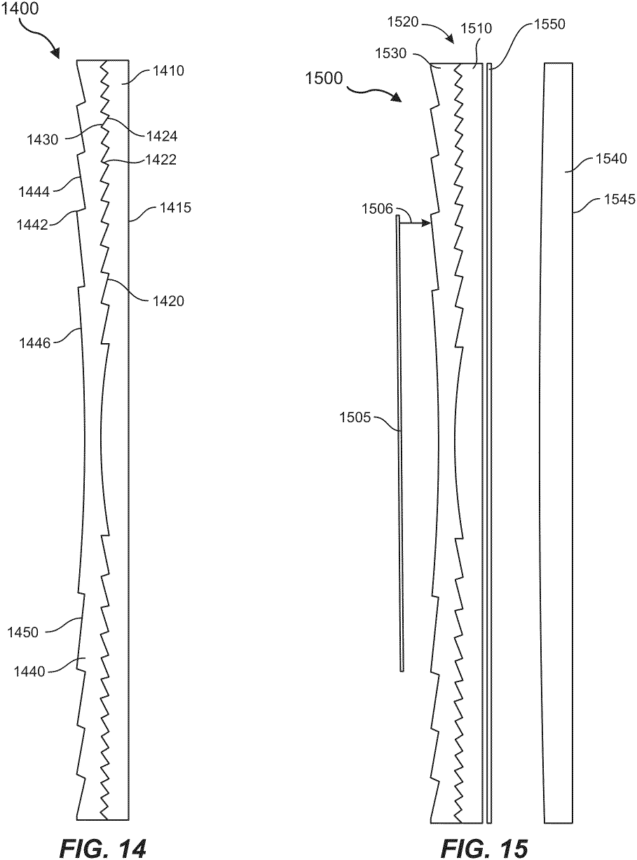

FIG. 14 shows a further example Fresnel lens assembly 1400 including a Fresnel lens 1410 having a planar surface 1415 and a faceted surface 1420. The faceted surface 1420 supports a reflective polarizer 1430. In some examples, the reflective polarizer may only be located on the facets 1424 and not located on steps 1422. A filler polymer layer 1440 may conform to the faceted surface 1420 (and the deposited reflective polarizer 1430) and may be formed with exterior surface 1450. The exterior surface 1450 may include steps such as step 1442 and facets 1444. In this example, the filler polymer layer is configured as a lens having an exterior faceted surface configured as a concave lens, for example, including concave facets such as central concave facet 1446. In some examples, the reflective polarizer may be replaced by a reflector or beamsplitter.

In some examples, a Fresnel lens may include a reflective polarizer formed as a layer on one or more of the lens facets. The reflective polarizer may include a multilayer optical film, cholesteric liquid crystal, or an arrangement of anisotropic conductors. The facets and coating may be embedded in an optically clear layer, such as a filler polymer. The refractive indices and optical dispersions of the Fresnel lens material and the filler polymer may be selected to reduce chromatic aberration (e.g., colored fringes in the image). In some examples, optical materials (e.g., used in a Fresnel lens) may have a low birefringence (e.g., corresponding to less than a quarter wavelength optical retardance). In some examples, a Fresnel lens and/or filler polymer may include a silicone polymer such as polydimethylsiloxane (PDMS), cyclic olefin polymer (COP), cyclic olefin copolymer (COC), polyacrylate, polyurethane, or polycarbonate. For example, a PDMS Fresnel lens may be supported on a rigid substrate such as glass. Vapor deposition of coatings may lead to unwanted deposition on the risers between facets. Appropriately sectioned coating layers may be selectively located on the facets of a Fresnel lens using an elastomeric substrate. Fresnel lens supported reflective polarizers may be used in augmented reality and/or virtual reality (AR/VR) systems. Other components may include a display and a beamsplitter. In some examples, an AR/VR system may include a Fresnel lens supported beamsplitter, and lenses may be optimized separately. Fresnel lenses may be concave, convex, or may have complex optical profiles such as freeform surfaces. Wavelength-dependent properties may be adjusted by, for example, adjusting multilayer film configurations. Applications may also include IR rejection in, for example, imaging, display, or photovoltaic systems

In some examples, a reflective polarizer may conform to the facets of a Fresnel lens. The facets may be generally planar or in some examples, may be curved to provide a portion of the surface curvature of a concave, convex, aspheric, cylindrical, freeform, or any other lens. In some examples, the filler polymer layer may be formed after adhesion of the reflective polarizer to the facets of the Fresnel lens. In some examples, the reflective polarizer may be a layer sandwiched between the Fresnel lens and an optical element (e.g., a second lens) formed by the filler polymer. A method of fabricating a Fresnel lens assembly may include depositing a reflective polarizer on the facets of a Fresnel lens, then forming a second lens on the reflective polarizer and any portions of the Fresnel lens surface that do not support a portion of the reflective polarizer (e.g., steps between facets, sometimes referred to as risers).

In some examples, an optical configuration including at least one Fresnel lens assembly (e.g., as described herein) may allow increased apparatus efficiency, particularly for AR/VR applications. For example, the image of the display may be formed using light beams within +/- 20 degrees of the chief ray (typically, corresponding to a ray emitted normal to the surface of the display). Example displays include light-emitting diode (LED) displays, such as organic LED (OLED) displays, which are generally more efficient for imaging using these approximately on-axis rays.

The Fresnel lens assembly 1400 may be configured in other arrangements. In some examples, the Fresnel lens assembly 1400 may include a Fresnel lens 1410 that includes a first polymer, and a second Fresnel lens (e.g., formed by the filler polymer layer 1440) that may include a second polymer. The optical properties of the first and second polymers may be configured to reduce chromatic aberration of the Fresnel lens, for example, by having different optical dispersions (e.g., wavelength-dependent values of refractive index). An example reflective polarizer may include layers formed on the faceted interface between the two Fresnel lenses (e.g., layers formed on or proximate the faceted surface 1420), or on any other faceted surface of one or both Fresnel lenses. For example, one or both of the Fresnel lenses may support a reflective polarizer using any suitable approach, and the two lenses may then be bonded together so that, in some examples, the reflective polarizer is located at the interface between the two lenses.

FIG. 15 shows an optical configuration 1500 including a first Fresnel lens assembly 1520 (that may be similar to Fresnel lens assembly 1400 discussed above in relation to FIG. 14, including Fresnel lens 1510 and reflective polarizer 1530) and second Fresnel lens assembly 1540 (that may be similar to Fresnel lens assembly 1360 discussed above in relation to FIG. 13). The optical configuration 1500 may further include optical film 1550 that may include an optical retarder. The optical configuration 1500 may be configured to receive light from a display 1505 (e.g., including representative light beam 1506). The propagation of light from the display through the optical configuration may be similar to that discussed above in relation to FIG. 13. Light from the display 1505 may pass through the optical configuration 1500 and through surface 1545 towards the eye of a user when the user wears an example apparatus, such as a head-mounted device, including the optical configuration.

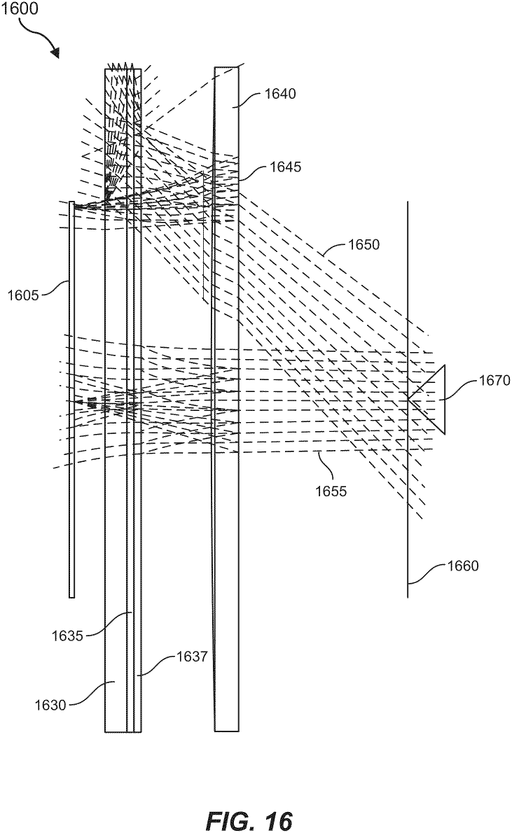

FIG. 16 qualitatively illustrates various possible beam directions within an optical configuration. This figure is for illustrative purposes only and is not limiting, and includes possible directions of multiply-reflected and/or stray light beams. The optical configuration 1600 may receive light from a display 1605, shown as representative beams denoted by dashed lines, including a first ray bundle 1650 from an edge portion of the display 1605 and a second ray bundle 1655 from a center portion of the display 1605. The light from the display may pass through first Fresnel lens assembly 1630 and second Fresnel lens assembly 1640. Each Fresnel lens assembly may include a combination of a Fresnel lens and a reflective polarizer. For example, a reflective polarizer 1637 (or, in some examples, a beamsplitter) may be located at the right hand surface (as illustrated) of the first Fresnel lens assembly 1630. In some examples, a reflective polarizer 1645 may be located at the right-hand surface (as illustrated) of the second Fresnel lens assembly 1640. The optical film 1635 may represent an optical retarder and, in some examples, the locations of the optical retarder and reflective polarizer may be interchanged. The line 1660 may represent a plane of focus for an image of the display. The triangle 1670 may be a schematic representation of a possible location of an eyebox. In this example, the eyebox may represent an approximate position where an eye of the user may be located to view the display.

In some examples, a method may include forming a reflective polarizer on a substrate, patterning the reflective polarizer to form reflective polarizer portions sized to match corresponding facets of a Fresnel lens, and applying the reflective polarizer portions to the corresponding facets of the Fresnel lens. Example methods may include methods of fabricating and/or using an optical element or apparatus including an optical element. The reflective polarizer portions may be sized or patterned with laser ablation or any other suitable method to remove the portion corresponding to the step portion (sometimes referred to as the draft surface) of the Fresnel lens. Applying the reflective polarizer portions to the corresponding portions of the Fresnel lens may include urging the reflective polarizer portions against the corresponding facets of the Fresnel lens using a force applied to the substrate. Forming the reflective polarizer on the substrate may include forming the reflective polarizer on an elastomer element. The force may be applied using air pressure to inflate the substrate so that a uniform force is applied to the Fresnel facets. For example, the polarizer may be formed on an elastomer element or other substrate, such as a polymer film. In some examples, a polymer film may be an elastomer element, for example, a polymer film including a polymer elastomer. An example method may further include removing the substrate so that reflective polarizer portions remain bonded to the corresponding portions of the Fresnel lens. The reflective polarizer may be adhered to the substrate using a UV reversible adhesive or a thermally reversible adhesive. After the reflective polarizer is adhered to the Fresnel facets, the substrate can be removed by applying UV irradiation or thermal debonding, and the reflective polarizer may remain adhered to the faceted surface of the Fresnel lens after substrate reversal.

FIG. 17 shows an example method 1700 for fabricating a Fresnel lens assembly. The method includes forming reflective polarizer portions on a support substrate (in this example, an elastomer) by bonding the reflective polarizer to the elastomer (1705), coating and patterning an etch stop on the reflective polarizer (1710), etching the reflective polarizer into reflective polarizer portions (1715), and removing the etch stop (1720). After these process steps, reflective polarizer portions sized to match the corresponding facets of a Fresnel lens may be supported by a substrate, such as an elastomer. For example, the reflective polarizer portions may include a central circular portion surrounded by concentric ring-shaped portions. Example reflective polarizer portions may encircle a central portion (e.g., a reflective polarizer portion adhered to a central circular facet of a Fresnel lens), may be generally concentric, and portion configurations (e.g., shapes and sizes) may correspond to those of respective facets of the Fresnel lens.

The method 1700 may also include providing a Fresnel lens having an adhesive layer coated on the facets of the Fresnel lens by forming a Fresnel lens (1725) and coating the Fresnel lens with the adhesive layer (1730).

The method 1700 may further include locating the reflective polarizer portions on the facets of the Fresnel lens by aligning the reflective polarizer portions to the corresponding facets of the Fresnel lens (1740), urging (e.g., pressing) the reflective polarizer portions against corresponding facets of the Fresnel lens (1750), and removing the substrate (e.g., an elastomer) from the reflective polarizer (1760), leaving the reflective polarizer portions attached to the facets by the adhesive layers. In some examples, the substrate may be removed using a heating step or a UV irradiation step. An optional protective coating may be applied to the Fresnel lens (1770), for example, including or in addition to a filler polymer. In some examples, the protective coating may provide, include, or be a component of a filler layer. An example protective coating (e.g., a filler layer) may include an optically transparent polymer. The method provides a Fresnel lens assembly including a Fresnel lens and a reflective polarizer located at least on one or more facets thereof (1780), where the method may optionally further include applying or otherwise including one or more additional layers, for example, an antireflection coating, an additional reflective layer, an optically absorbing layer, an optically absorbing polarizer, a scratch-resistant layer, a lens, and the like.

FIG. 18 illustrates an example method of fabricating a Fresnel lens assembly including a Fresnel lens and a reflective polarizer. The method (1800) includes forming a reflective polarizer on a substrate (1810), patterning the reflective polarizer (1820) to form reflective polarizer portions sized to match the facets of a Fresnel lens, and applying the portions of the reflective polarizer to corresponding portions of the Fresnel lens (1830). This may include urging the reflective polarizer against the faceted surface of the Fresnel lens using the substrate, such as a substrate including an elastomer element. The substrate may then be removed so that the reflective polarizer remains attached to the Fresnel lens. The substrate may be removed by any appropriate method, including physical motion (e.g., pulling the substrate away from the Fresnel lens leaving the reflective polarizer supported by the Fresnel lens), ablation, etching, heating, melting, vaporization, sublimation, burning, irradiation (e.g., by UV radiation) or any other suitable method (or combination of methods) of physical and/or chemical removal of the substrate or combinations thereof.

FIG. 19 illustrates a method of fabricating a Fresnel lens assembly including a Fresnel lens and a reflective polarizer. The method (1900) includes forming a reflective polarizer on an elastomer element (1910), urging the reflective polarizer against a surface of the Fresnel lens using the elastomer element (1920), and removing the elastomer element so that the reflective polarizer remains attached to the Fresnel lens (1930).

In some examples, the reflective polarizer may be formed as a layer and then die-cut or otherwise processed to form appropriately sized reflective polarizer portions. The portions may be sized to match respective corresponding facets of a Fresnel lens. A reflective polarizer layer may be divided into portions using an approach such as laser ablation, die-cutting, etching, lithography, mechanical scoring, or any suitable approach. In some examples, the reflective polarizer may be formed on an elastomer element.

In some examples, the reflective polarizer may not be divided into portions. For example, a reflective polarizer may be thermoformed or otherwise attached to the Fresnel lens, and regions of the reflective polarizer may be removed (e.g., from the steps between facets), for example, using patterned refractive ion etching, diamond machining, and the like.

In some examples, the arrangements, the steps 1740 - 1760 of the method described in relation to FIG. 17 may be performed by an arrangement such as discussed in relation to FIGS. 8A - 8C, and may be performed by a device fabrication apparatus including the components such as those discussed above in relation to FIGS. 8A - 8C.

In some examples, a method of making a Fresnel lens assembly including a reflective polarizer and a Fresnel lens includes the steps of providing a structured transparent substrate where at least one side of the substrate has at least two facets separated by a riser, where the reflective polarizer layer is bonded to the facets of the structured substrate. The reflective polarizer may be supported by an elastomer element, and the reflective polarizer may be transferred to the facets of a Fresnel lens by the application of pressure (e.g., including the application of a force to the elastomer element and/or the Fresnel lens to urge the reflective polarizer against the facets of the Fresnel lens. In some examples, at least the facets of the Fresnel lens and/or the reflective polarizer are coated with a layer of adhesive before the application of pressure. For example, a surface of the reflective polarizer that is urged in contact with the facets of the Fresnel lens may have a layer of adhesive. The adhesive may include a pressure sensitive, thermally activated, or photocurable material.

In some examples, the reflective polarizer may be patterned to be in registration with the facets of the Fresnel lens. The patterned reflective polarizer may be formed on an elastomer element, aligned with the facets, and then the elastomer element may be moved (e.g., by an actuator) so that the patterned reflective polarizer is urged in contact with the facets of the Fresnel lens.

The bond strength of the reflective polarizer to the elastomer may be lower than the bond strength to the facets so that the reflective polarizer remains adhered to the facets as the elastomer element is withdrawn from the facets. In some examples, the reflective polarizer may be removed (e.g., de-bonded) from the elastomer using a lift-off process, such as laser lift-off. Laser lift-off may include a process for separating two layers of material where there is a thin layer at the interface between the two layers that may be ablated by laser radiation (e.g., from a pulsed or scanned laser).

In some examples, a method of making a Fresnel lens assembly including a Fresnel lens and a reflective polarizer includes: providing a substrate having at least two adjacent facets that are separated by a step (sometimes termed a riser) and conforming and bonding a reflective polarizing film to the faceted substrate. A method may further include removing the reflective polarizer film from the risers.

In some examples, a reflective polarizer may be fabricated by applying an alignment layer (e.g., a polymer layer or grating) and applying at least one layer of a cholesteric liquid crystal (CLC) which is at least partially aligned to alignment layer. The alignment layer may include a photoalignment material (PAM) that may be deposited on a substrate, and a desired molecular orientation may be obtained by exposing the PAM to polarized light (such as ultraviolet (UV) and/or visible light). A CLC may be further processed to lock the molecular alignment of a CLC within a solid material, for example, to provide a chiral material such as a chiral solid. For example, a CLC may be polymerized, cross-linked, and or a polymer network may be formed through the CLC to stabilize the alignment to provide a chiral solid. A chiral solid may be referred to as a CLC-based material if a CLC phase was used in its preparation. In some examples, a CLC may be formed using an effective concentration of chiral dopant within a nematic liquid crystal, and the chiral nematic (cholesteric) mixture may further include polymerizable materials.

In some examples, a reflective polarizer may include a chiral material such as a material having molecular ordering similar to that of a cholesteric liquid crystal, such as a solid material derived from cooling, polymerizing, cross-linking, or otherwise stabilizing the molecular order of a cholesteric liquid crystal. For example, a chiral solid may be a solid having a helical optical structure similar to that of a cholesteric liquid crystal. For example, a direction of maximum refractive index may describe a helix around a normal to the local direction of molecular orientation.

In some examples, a reflective polarizer may include a birefringent multilayer optical film that may be conformed to a faceted substrate (e.g., of a Fresnel lens) through a combination of heat and pressure.

In some examples, a polarizing beam splitter may include a transparent lens with a first and a second surface, where the first surface is a Fresnel lens, and the second surface is adjacent to a reflective polarizing layer. At least one of the first and second surfaces may have a cylindrical, spherical, or aspherical curvature.

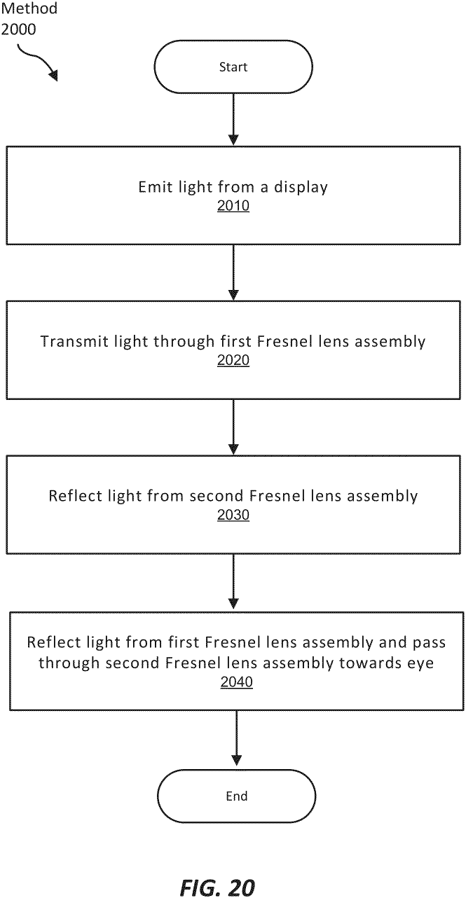

FIG. 20 shows an example method of operation (2000) which may be performed, for example, by an apparatus such as a head-mounted device, such as an AR/VR device. The method may include emitting light (e.g., including one or more light rays) from a display (2010), transmitting the light through a first Fresnel lens assembly (2020), reflecting the light from a second Fresnel lens assembly (2030), and reflecting the light from the first Fresnel lens assembly through the second Fresnel lens assembly and towards an eyebox (2040), for example, where a user may view an image of the display when the user wears the device. The eye of a user may be located at the eyebox (e.g., a location of display image formation) for viewing the image of the display. The first Fresnel lens assembly may include a first Fresnel lens and a first reflective polarizer. The second Fresnel lens assembly may include a second Fresnel lens and a second reflective polarizer.

In some examples, an optical retarder may be located between the first and second Fresnel lens assemblies, and the light from the display may pass through the optical retarder on a plurality of occasions (e.g., three times) before being transmitted through the second Fresnel lens assembly towards the eye of the user. In some examples, light may be emitted from the display with a polarization, such as a linear polarization or a circular polarization. The polarization may be modified by the optical retarder each time the light passes through the optical retarder. Reflections may also modify the polarization of light. For example, light (e.g., polarized light) from the display may be transmitted through the first Fresnel lens assembly, pass through the optical retarder, be reflected by the second Fresnel lens assembly, pass through the optical retarder, be reflected by the first Fresnel lens assembly, pass through the optical retarder, and then be transmitted by the second Fresnel lens assembly towards the eye of a user, where the light may be incident on the reflective polarizer with a first linear polarization, which may be reflected by the reflective polarizer of the second Fresnel lens assembly. Light may reflect from the reflective polarizer of the first Fresnel lens assembly and may then be transmitted by the reflective polarizer. In some examples, at least one of the Fresnel lens assemblies may include an optical retarder and the separate optical retarder may be omitted from the optical configuration.

In some examples, the image brightness provided by the display (e.g., including a display panel) using an optical configuration may include spatially adjusting the spatial profile of the illumination brightness of a light source (e.g., a backlight) and/or an emissive display. Display brightness may be adjusted as a function of one or more display parameters, such as spatial position on the display (e.g., spatial variations in image brightness), power consumption, aging effects, eye response functions, and/or other parameter(s).

In some examples, a method may include emitting light having circular or linear polarization from a display; transmitting the light through a first Fresnel lens assembly; reflecting the light from a second Fresnel lens assembly; and reflecting the light from the first Fresnel lens assembly through the second Fresnel lens assembly and towards an eye of a user. The apparatus may be configured so that the light is transmitted through the first Fresnel lens assembly having a first polarization and reflected by the first Fresnel lens assembly having a second polarization. This may be achieved using an optical retarder located between the first and second Fresnel lens assemblies and/or using changes in polarization on reflection. A display may inherently emit polarized light or, in some examples, a suitable polarizer may be associated with (e.g., attached to) a surface through which light from the display is transmitted.

Example methods include computer-implemented methods for operating an apparatus, such as an apparatus as described herein such as a head-mounted display or an apparatus for fabricating a Fresnel lens assembly. The steps of an example method may be performed by any suitable computer-executable code and/or computing system, including an apparatus such as an augmented reality and/or virtual reality system. In some examples, one or more of the steps of an example method may represent an algorithm whose structure includes and/or may be represented by multiple sub-steps. In some examples, a method for providing a uniform image brightness from a display using a folded optic configuration may include using a display panel that is configured to allow a spatial variation of the display brightness. In this context, light from a display may be reflected at least once (e.g., twice) within a folded optic configuration before reaching the eye of a user.

In some examples, an apparatus, such as a head-mounted device or system, may include at least one physical processor and physical memory including computer-executable instructions that, when executed by the physical processor, cause the physical processor to generate an image on the display. The image may include a virtual reality image element and/or an augmented reality image element. The apparatus may include an optical configuration such as described herein.

In some examples, a non-transitory computer-readable medium may include one or more computer-executable instructions that, when executed by at least one processor of an apparatus (e.g., a head-mounted device), cause the apparatus to provide an augmented reality image or a virtual reality image to the user (e.g., the wearer of the head-mounted device). The apparatus may include an optical configuration such as described herein.

A Fresnel lens assembly may include a Fresnel lens and a reflective polarizer. For example, at least one facet of a Fresnel lens may support a reflective polarizer. A Fresnel lens may include a plurality of facets and steps formed in an otherwise planar surface, a cylindrical surface, a freeform surface, a surface defined at least in part by a Zernike function, or a spherical surface. A Fresnel lens assembly may include additional components, such as a substrate, filler polymer layer, or any suitable optical element.

In some examples, a Fresnel lens assembly may include a Fresnel lens and a reflective polarizer. In some examples, the reflective polarizer may be supported by (e.g., deposited on, adhered to, or otherwise supported by) the facets of the Fresnel lens.

In some examples, the reflective polarizer may include a cholesteric liquid crystal, a birefringent multilayer optical film, or a wire grid. In some examples, a reflective polarizer may include an arrangement of electrically conductive elements, such as wires, rods, tubes, or other conductive elements Electrically conductive elements may include at least one metal (e.g., copper, gold, silver, or other metal or alloy thereof), electrically conductive carbon allotrope, doped semiconductor, or the like. In some examples, a reflective polarizer may include a birefringent multilayer film, and the skin layer or layers may have a pass polarization refractive index that is within 0.2 of the average refractive index of the multilayer film, and in some examples, a refractive index that differs from the average refractive index of the multilayer film by at least approximately 0.02, such as at least approximately 0.05, for example, at least approximately 0.1. In some examples, a reflective polarizer may include a multilayer assembly including at least one optically isotropic layer adjacent to (e.g., alternating with) a birefringent (e.g., uniaxial) polymer layer. Layers may be generally parallel and may conform to an underlying optical element that may act as a substrate. An optically isotropic polymer layer may include an optically transparent polymer. A birefringent polymer layer may include an anisotropic polymer layer, such as a stretched or otherwise at least partially molecularly aligned polymer layer. For example, a polymer layer may be stretched by a factor of between 1.5 and 10 (e.g., stretched by a ratio of between 1.5:1 and 10:1, where the ratio represents a ratio of a final extent along a particular direction to an initial extent).

In some examples, a Fresnel lens assembly including a reflective polarizer may further include a filler layer. The filler layer may include an optically clear layer that is located on the structured surface of the Fresnel lens assembly. For example, a filler layer may conform to the facets and steps of a structured surface (e.g., of a Fresnel lens) and has a second surface without facets or steps, for example, a generally smooth surface. For example, the filler layer may have a planar, concave or convex surface that may also be an exterior surface or support one or more additional layers, such as an antireflection layer or other optical layer. A reflective polarizer may be formed on a facet of a structured optical element, such as a Fresnel lens. In some examples, a reflective polarizer may include a multilayer reflective polarizer including at least one birefringent layer. In some examples, a reflective polarizer may include one or more polymer layers and/or one or more inorganic layers.

In some examples, a structured optical element may include a substrate having a surface including facets and steps, where the steps are located between neighboring (e.g., proximate or substantially adjacent) facets. A reflective polarizer may be located adjacent to and conforming to at least a portion of a faceted surface. In some examples, a faceted surface may correspond to a surface portion of a refractive lens, such as a convex or concave surface, and may be curved. In some examples, a facet may be planar and may approximate a surface portion of a refractive lens. For example, a planar faceted surface may have an orientation to the optic axis of the lens that varies with the average (e.g., mean) radial distance of the facet from the optical center of the lens. In this context, a structured optical element may include surface facets separated by steps, and at least one facet of a Fresnel lens may support a reflective polarizer. The filler material may then coat a surface of a Fresnel lens assembly (e.g., including facets, steps and the reflective polarizer). The filler layer may have a first surface having a profile that is complementary to the Fresnel lens assembly, and a second surface (e.g., an exterior surface) that may be a planar surface. In some examples, the second surface of the filler material may have a curved surface, such as a convex, concave, cylindrical, freeform, or other curved surface, or, in some examples, may include a second Fresnel lens structure.

In some examples, the reflective polarizer layer may have an average refractive index for the pass polarization, and the filler layer may have a refractive index that differs from the average refractive index of the reflective polarizer by less than 0.2, for example, by less than 0.1, such as less than 0.05, for example, by less than 0.02.

In some examples, the steps between facets may have step heights and/or draft angles that may be a function of position within the optical element, for example, a function of radial distance from the optical center of a lens. In some examples, the gap between adjacent reflective polarizer segments may vary as a function of position within the optical element, such as a function of radial distance from the optical center of the lens.

In some examples, an apparatus (e.g., a head-mounted device such as an AR and/or VR device) may include an optical configuration including a pancake lens (e.g., a combination of a lens and a beamsplitter, which may also be termed a beamsplitter lens) and a reflective polarizer. An example reflective polarizer may be configured to reflect a first polarization of light and transmit a second polarization of light. For example, a reflective polarizer may be configured to reflect one handedness of circularly polarized light (e.g., right or left) and transmit the other handedness of circularly polarized light (e.g., left or right, respectively). For example, a reflective polarizer may be configured to reflect one direction of linear polarized light (e.g., vertical) and transmit an orthogonal direction of linearly polarized light (e.g., horizontal). In some examples, the reflective polarizer may be adhered to the facets of a Fresnel lens.

The optical configuration may be termed a folded optic configuration, and in this context, a folded optic configuration may provide a light path that includes one or more reflections and/or other beam redirections. An apparatus having a folded optic configuration may be compact, have a wide field-of-view (FOV), and allow formation of high-resolution images. Higher lens system efficiency may be useful for applications such as head-mounted displays (HMDs), including virtual reality and/or augmented reality applications.

An example apparatus, which may also be referred to as a device, may include a display, a pancake lens (e.g., including a beamsplitter or polarized reflector that may be formed as a coating on a lens surface), and a reflective polarizer (e.g., configured to reflect a first polarization of light and transmit a second polarization of light, where the first polarization and second polarization are different). For example, a reflective polarizer may be configured to reflect one handedness of circular polarized light and transmit the other handedness of circularly polarized light

Folded optic configurations may be compact, have a wide field-of-view (FOV), and provide higher resolution for a given distance between the display and a viewer. However, a folded optic configuration including a pancake lens may have a lower efficiency than a non-folded optical configuration including refractive lenses but no reflective elements. System efficiency of an optical configuration is important, for example, for applications in head-mounted displays (HMDs). Reduced efficiency can reduce the usability of an AR/VR device and may create discomfort due to higher temperatures as a result of an increased power consumption required by the display to provide a desired image brightness. In some examples, system efficiency is increased using a pancake lens including a beamsplitter that has higher reflectance toward the edges of the beamsplitter than within a central region of the beamsplitter. Lens efficiency may be increased using a polarization-converting beamsplitter lens including a beamsplitter that has higher reflectivity toward the edges of the lens than within a central region of the lens. In some examples, a pancake lens may include a refractive lens and a beamsplitter that may be formed as a reflective coating on a surface of the lens. The reflective coating may have a spatially varying reflectance. In some examples, a pancake lens may include a polarization-converting beamsplitter lens.

In some examples, a reflective polarizer may include a cholesteric liquid crystal, such as a polymer cholesteric liquid crystal. In some examples, a reflective polarizer may include a birefringent multilayer reflective polarizer. In some examples, an apparatus may further include an optical retarder, such as a quarter wave retarder, located between the beamsplitter and the reflective polarizer.

Example reflective polarizers (or other polarizers) may include polarizing films. An example polarizing film may include one or more layers, such as an optical polarizer including a combination of a reflective polarizer and a dichroic polarizer, for example, bonded together.

In some examples, a Fresnel lens assembly may include a Fresnel lens and a beamsplitter (e.g., instead of or additional to the polarizing reflector shown in various examples herein). A beamsplitter may be configured to reflect a first portion of incident light and transmit a second portion of incident light. In some examples, a beamsplitter lens may be used with a Fresnel lens assembly. A beamsplitter may be formed on the facets of a Fresnel lens using approaches adapted from those described herein. For example, a beamsplitter may be formed on an elastic element. A beamsplitter may be formed on a substrate and patterned to form portions sized to match the facets of a Fresnel lens.

Reflective layers may be formed by one or a combination of processes including thin film physical vapor deposition, chemical vapor deposition, or other suitable processes for depositing reflective layers, such as highly and/or partially reflective thin film coatings. An example reflective layer may include one or more metals such as aluminum or silver, and may be metallic. An example reflective layer may include one or more dielectric materials such as silica, aluminum oxide, hafnium oxide, titanium dioxide, magnesium oxide, magnesium fluoride, indium tin oxide, indium gallium zinc oxide, and the like, and mixtures thereof. An example reflective layer may include one or more dielectric layers, and may include a Bragg grating structure or similar multilayer structure.

An example beamsplitter may include one or more regions having different transmissivity and/or reflectance, and may include one or more reflective layers. An example beamsplitter may include first and second regions, having a different reflectance, for example, for visible light or at least one visible wavelength of light. A beamsplitter may include a coating formed on a surface of the lens, such as a metal coating and/or a dielectric coating such as a dielectric multilayer. In some examples, the reflectance of the beamsplitter may vary as a function of spatial position within the beamsplitter. For example, a beamsplitter may include a first region having a first reflectance and a second region having a second reflectance. In some examples, a beamsplitter may have a higher reflectance toward the edges of the beamsplitter than within a central region of the beamsplitter.

An example beamsplitter may include a coating that is partially transparent and partially reflective. An example beamsplitter may include a thin coating including a metal such as gold, aluminum or silver. A thin coating may have a coating thickness in the range of approximately 10 nm to approximately 500 nm. An example beamsplitter may include one or more layers, such as dielectric thin film layers. In some examples, a beamsplitter may include at least one dielectric material, for example, as a dielectric layer or component thereof, such as silica, aluminum oxide, hafnium oxide, titanium dioxide, magnesium oxide, magnesium fluoride, and the like. An example beamsplitter may include a coating including at least one thin metal coating and/or at least one dielectric coating. An example beamsplitter may include at least one of an electrically conductive material (e.g., a metal, an electrically conductive metal oxide such as, indium tin oxide or indium gallium zinc oxide, or other conductive material) and a dielectric material, and may include a combination of an electrically conductive material and a dielectric material (e.g., as a coating including at least one layer).

In some examples, a beamsplitter may be formed on a convex, planar, or concave surface of a lens. In some examples, the lens may include a Fresnel lens. In some examples, a polarized reflector may be configured to function as a beamsplitter and may, for example, be configured to reflect a first percentage of a first polarization of light and a second percentage of a second polarization of light, where the first and second percentages may be different, while transmitting some, most, or effectively all of the non-reflected light.

An example reflector (e.g., a beamsplitter, polarized reflector, or other reflector) may include at least a first and a second region, where the first region may include a central region of the reflector, and the second region may include an outer region of the reflector. In some examples, a reflector (e.g., a beamsplitter or a polarized reflector for a particular polarization) may have a reflectance of about 100%, about 95%, about 90%, about 85%, about 80%, about 75%, about 70%, or within a range between any two examples values of these example reflectance values. For example, the second region may have a reflectance between approximately 75% and approximately 100%, such as a reflectance between approximately 85% and approximately 100%. In some examples, the second region may have a higher reflectance than the first region, such as at least 10% higher reflectance. In some examples, the relationship between reflectance and distance may be a monotonic smooth curve. In some examples, the relationship between reflectance and distance may be discontinuous or include transition regions with relatively high rates of change in reflectance. In some examples, there may be a gradual transition in reflectance of the beamsplitter from the first region to the second region within a transition region. The transition region may have a width (which may be termed a transition distance) that may be less than about 5 mm, such as less than 2 mm, such as less than 1 mm. In some examples, the transition region width may be less than 0.1 mm, such as less than 0.01 mm.

In some examples, a reflector (e.g., a beamsplitter or polarized reflector) may include a layer that is partially transparent and partially reflective. In some examples, a reflector may include a metal film formed on a substrate, such as a substrate including one or more optical materials. For example, the layer may include a metal layer (e.g., having a thickness between about 5 nm and about 500 nm, such as a thickness between 10 nm and 200 nm), such as a layer including one or more metals such as aluminum, silver, gold, or other metal such as an alloy. The layer may include a multilayer, and may include a corrosion protection layer supported by the exposed surface of the layer (e.g., on a metal layer). In some examples, the layer may include one or more dielectric layers, such as dielectric thin film layers. Dielectric layers may include one or more dielectric layers such as oxide layers (e.g., metal oxide layers or other oxide layers), nitride layers, boride layers, phosphide layers, halide layers (e.g., metal halide layers such as metal fluoride layers), or other suitable layers. In some examples, the device may include one or more metal layers and/or one or more dielectric layers. A substrate may include glass or an optical polymer.

In some examples, an apparatus may include a display, at least one Fresnel lens assembly including a polarized reflector, and optionally a beamsplitter lens including a beamsplitter. The reflectance of the beamsplitter and/or the polarized reflector may vary as a function of spatial position; for example, including a first region of relatively high optical transmission and a second region of relatively low optical transmission (e.g., of relatively higher reflectance). In this context, a segmented reflector may have at least two regions having different optical properties, such as regions of different values of reflectance, for example, for one or more visible wavelengths.

In some examples, a device may include a reflector having a gradual or effectively discontinuous transition in the reflectance of the reflector from the first region to the second region. A transition region may be located between the first region and the second region. As measured along a particular direction (e.g., a radial direction, normal to the periphery of the first region, or other direction) the transition region may extend over a transition distance between the first region and the second region. In some examples, the transition distance may have a length that is approximately or less than 5 mm, 1 mm, 0.1 mm, or 0.01 mm.

In some examples, a reflector may provide selective reflection over a particular wavelength range and/or for a particular polarization. For example, a reflector may include a Bragg reflector, and layer composition and/or dimensions may be configured to provide a desired bandwidth of operation.

In some examples, a reflector may be formed on an optical substrate such as a lens, and a combination of a lens and a reflector may be termed a reflector lens. A reflector lens may include an optical element having at least one curved surface. A reflector may include a reflective coating formed on or otherwise supported by a planar or a curved surface of an optical element such as a lens.

During fabrication of a reflector, different reflector regions having different values of optical reflectance may be defined by a masked deposition processes or using photolithography, or a combination thereof.

In some examples, a lens (such as a Fresnel lens) may include a surface such as a concave surface, a convex surface or a planar surface. In some examples, a device may include one or more converging lenses and/or one or more diverging lenses. An optical configuration may include one or more lenses and may be configured to form an image of at least part of the display at an eyebox. A device may be configured so that an eye of a user is located within the eyebox when the device is worn by the user. In some examples, a lens may include a Fresnel lens having facets formed on a substrate including an optical material. In some examples, an optical configuration may include one or more reflectors, such as mirrors and/or reflectors.

In some examples, a component of an optical configuration may include one or more optical materials. For example, an optical material may include glass or an optical plastic. An optical material may be generally transmissive over some or all of the visible spectrum. In some examples, an optical component including a generally transmissive material may have an optical transmissivity of greater than 0.9 over some or all of the visible spectrum.

In some examples, a substrate (e.g., for a reflector), an optical material, and/or a layer (e.g., of an optical component) may include one or more of the following: an oxide (e.g., silica, alumina, titania, other metal oxide such as a transition metal oxide, or other non-metal oxide); a semiconductor (e.g., an intrinsic or doped semiconductor such as silicon (e.g., amorphous or crystalline silicon), carbon, germanium, a pnictide semiconductor, a chalcogenide semiconductor, or the like); a nitride (e.g., silicon nitride, boron nitride, or other nitride including nitride semiconductors); a carbide (e.g., silicon carbide), an oxynitride (e.g., silicon oxynitride); a polymer; a glass (e.g., a silicate glass such as a borosilicate glass, a fluoride glass, or other glass); or other material.

In some examples, an apparatus may include a display (e.g., a display panel) and a folded optic lens optionally having a segmented reflectance such as described herein. Light from the display panel incident on the folded optic lens may be circularly polarized. The display may be an emissive display or may include a backlight. An emissive display may include a light-emitting diode (LED) array, such as an OLED (organic light-emitting diode) array. In some examples, an LED array may include a microLED array, and the LEDs may have a pitch of approximately or less than 100 microns (e.g., approximately or less than 50 microns, approximately or less than 20 microns, approximately or less than 10 microns, approximately or less than 5 microns, approximately or less than 2 microns, approximately or less than 1 microns, or other pitch value).

In some examples, the display may emit polarized light, such as linearly polarized light or circularly polarized light. In some examples, the display may emit linear polarized light and an optical retarder may convert the linear polarization to an orthogonal linear polarization. In some examples, the combination of an optical retarder and a linear reflective polarizer may be replaced with an alternative configuration, such as a circularly polarized reflective polarizer which may include a cholesteric liquid crystal reflective polarizer.

In some examples, the reflective polarizer may include a cholesteric liquid crystal, such as a polymer cholesteric liquid crystal, such as a cross-linked polymer cholesteric liquid crystal. In some examples, the reflective polarizer may include a birefringent multilayer reflective polarizer combined with a quarter wave retarder placed between the reflective polarizer and a second reflector (e.g., a beamsplitter or other reflective polarizer).

In some examples, the display may include a transmissive display (such as a liquid crystal display) and a light source, such as a backlight. In some examples, the display may include a spatial light modulator and a light source. An example spatial light modulator may include a reflective or transmissive switchable liquid crystal array.

In some examples, an apparatus may include a display configured to provide polarized light, such as circularly polarized light. A display may include an emissive display (e.g., a light-emitting display) or a display (e.g., a liquid crystal display) used in combination with a backlight.

In some examples, display light from the display incident on the beamsplitter lens is circularly polarized. The display may include an emissive display (such as a light-emitting diode display) or a light-absorbing panel (such as a liquid crystal panel) in combination with a backlight. An emissive display may include at least one LED array, such as an organic LED (OLED) array. An LED array may include a microLED array. An LED array may include LEDs having a pitch of less than about 100 microns (e.g., about 50 microns, about 20 microns, about 10 microns, about 5 microns, about 2 microns, or about 1 microns, etc.).

In some examples, a display may include a spatial light modulator and a light source (e.g., a backlight). A spatial light modulator may include a reflective or transmissive switchable liquid crystal array. In some examples, the light source (e.g., a backlight) may have and/or allow a spatial variation of illumination intensity over the display. In some examples, the light source may include a scanned source such as a scanned laser. In some examples, the light source may include an arrangement of light emissive elements, such as an array of light emissive elements. An array of light emissive elements may include an array of miniLED and/or microLED emissive elements.

In some examples, a display may include one or more waveguide displays A waveguide display may include a polychromatic display or an arrangement of monochromatic displays. A waveguide display may be configured to project display light from one or more waveguides into an optical configuration configured to form an image of at least part of the display at the eye box.

In some examples, the display brightness may be spatially varied to increase the imaged display brightness uniformity by at least, for example, about 10%, for example, about 20%, for example, about 30%, for example, about 40%, or by some other value. The display illumination variation may be dynamically controlled, for example, by a controller. In some examples, the dynamic illumination variation may be adjusted by a controller receiving eye tracking signals provided by an eye tracking system.

In some examples, the display may have a spatially adjustable brightness (e.g., a spatial variation in illumination intensity). In some examples, the adjustable brightness may be achieved by spatially varying the brightness of an emissive display or of a backlight. The display brightness and/or any spatial variation may be adjustable, for example, by a control circuit. In some examples, the light source may include a scannable light source, such as a laser. In some examples, the light source may include an array of light sources, such as an LED backlight. For example, the array of light sources may include a miniLED or microLED array. The display illumination may be spatially varied to increase the imaged display brightness uniformity by at least about 10% (e.g., about 20%, about 30%, about 40%, or other value). The spatial variation of illumination from the backlight may be dynamically adjusted, and the dynamic adjustment may be controlled by an eye tracking system.

In some example, an apparatus may include one or more actuators. For example, one or more actuators may be used to position a reflective polarizer relative to a Fresnel lens (e.g., to place reflective polarizer portions and the facets of the Fresnel lens in register) and/or to urge the reflective polarizer against a Fresnel lens (e.g., using an elastomer element).

Example actuators may include a piezoelectric actuator, which may include a piezoelectric material such as a crystal or ceramic material. Example actuators may include an actuator material such as one or more of the following: lead magnesium niobium oxide, lead zinc niobium oxide, lead scandium tantalum oxide, lead lanthanum zirconium titanium oxide, barium titanium zirconium oxide, barium titanium tin oxide, lead magnesium titanium oxide, lead scandium niobium oxide, lead indium niobium oxide, lead indium tantalum oxide, lead iron niobium oxide, lead iron tantalum oxide, lead zinc tantalum oxide, lead iron tungsten oxide, barium strontium titanium oxide, barium zirconium oxide, bismuth magnesium niobium oxide, bismuth magnesium tantalum oxide, bismuth zinc niobium oxide, bismuth zinc tantalum oxide, lead ytterbium niobium oxide, lead ytterbium tantalum oxide, strontium titanium oxide, bismuth titanium oxide, calcium titanium oxide, lead magnesium niobium titanium oxide, lead magnesium niobium titanium zirconium oxide, lead zinc niobium titanium oxide, lead zinc niobium titanium zirconium oxide as well as any of the previous mixed with any of the previous and/or traditional ferroelectrics including lead titanium oxide, lead zirconium titanium oxide, barium titanium oxide, bismuth iron oxide, sodium bismuth titanium oxide, lithium tantalum oxide, sodium potassium niobium oxide, and lithium niobium oxide. Also lead titanate, lead zirconate, lead zirconate titanate, lead magnesium niobate, lead magnesium niobate-lead titanate, lead zinc niobate, lead zinc niobate-lead titanate, lead magnesium tantalate, lead indium niobate, lead indium tantalate, barium titanate, lithium niobate, potassium niobate, sodium potassium niobate, bismuth sodium titanate, or bismuth ferrite. One or more of the above-listed example actuator materials may also be used as an optical material, a layer (e.g., of an optical component) or a substrate material (e.g., as a substrate for a beamsplitter). In some examples, an actuator may be configured to adjust the position and/or conformation of an optical element, such as a lens.

An example apparatus, such as a head-mounted device, may include a Fresnel lens assembly including a Fresnel lens and a reflective polarizer. An example reflective polarizer may be configured to reflect one polarization of light and transmit another polarization of light. For example, an example reflective polarizer may reflect one handedness of circularly polarized light and may transmit the other handedness of circularly polarized light. An example reflective polarizer may reflect one linear polarization direction and transmit an orthogonal linear polarization direction. An example apparatus may include a display, and the display may be configured to emit polarized light. In some examples, an apparatus may be an augmented reality and/or virtual reality (AR/VR) headset.

In some examples, a Fresnel lens assembly includes at least one Fresnel lens and is configured to reflect a first polarization of light and transmit a second polarization of light. The Fresnel lens assembly may include a reflective polarizing layer disposed on the facets of the structured surface of a Fresnel lens. In some examples, a structured optical element includes a substrate having at least two adjacent facets that are separated by a step (sometimes referred to as a riser), where the facets have facet surfaces, where a reflective polarizer layer is adjacent to and conforms to at least a portion of the facet surface of at least one of the facets.

In some examples, a Fresnel lens may have a reflective polarizer formed as a coating on the lens facets. The coating may include a multilayer optical film, cholesteric liquid crystal, or anisotropic conductors. The facets of the Fresnel lens and the polarizer may be embedded in an optically clear filler polymer. For example, a filler layer may be formed supported by an assembly including the Fresnel lens and the polarizer. The filler layer may include an optically transparent polymer. The filler layer may have a structured surface complementary to the Fresnel lens and any other coating disposed thereon, and a second surface that may be generally smooth (e.g., planar, concave, or convex) or, in some examples, may be faceted to provide additional optical power (e.g., using a second Fresnel lens formed in the filler layer). The refractive indices and optical dispersions of the Fresnel lens material and the filler polymer may be selected to reduce chromatic aberration (e.g., colored fringes in the image). Preferably, optical materials have low birefringence (e.g., less than ⍰/4 optical retardance). The Fresnel lens and/or filler polymer may include a silicone polymer such as polydimethylsiloxane (PDMS), cyclic olefin polymer (COP), cyclic olefin copolymer (COC), polyacrylate, polyurethane, or polycarbonate. For example, a PDMS Fresnel lens may be supported on a rigid substrate such as glass. Vapor deposition of coatings may lead to unwanted deposition on the risers between facets. Appropriately sectioned coating layers may be selectively located on the facets of a Fresnel lens using an elastomeric substrate. Fresnel lens supported reflective polarizers may be used in augmented reality and/or virtual reality (AR/VR) systems. Other components may include a display and a beamsplitter. In some examples, an AR/VR system may include a Fresnel lens supported beamsplitter, and lenses may be optimized separately. Fresnel lenses may be concave, convex, or may have complex optical profiles such as freeform surfaces. Wavelength-dependent properties may be adjusted by, for example, adjusting multilayer film configurations. Applications may also include IR rejection in, for example, imaging, display, or photovoltaic systems.

In some examples, an apparatus may include a display and an optical configuration configured to provide an image of a display, for example, in a head-mounted device. The optical configuration may include a Fresnel lens assembly including a Fresnel lens and a reflective polarizer. The Fresnel lens may have a structured surface including a plurality of facets, and there may be a step between pairs of neighboring facets. The reflective polarizer may include a plurality of reflective polarizer portions, where each reflective polarizer portion conforms to a corresponding facet of the Fresnel lens. The reflective polarizer may be configured to reflect a first polarization and transmit a second polarization of incident light. The optical configuration may form an image of the display viewable by a user when the user wears the apparatus. Examples also include other devices, methods, systems, and computer-readable media.

### Example Embodiments

Example 1: An example apparatus may include a Fresnel lens assembly, where the Fresnel lens assembly includes: a Fresnel lens and a reflective polarizer, where the Fresnel lens has a structured surface including a plurality of facets, the reflective polarizer includes a plurality of reflective polarizer portions, each reflective polarizer portion of the plurality of reflective polarizer portions conforms to a corresponding facet of the plurality of facets, the reflective polarizer is configured to reflect a first polarization of light incident on the reflective polarizer, and the reflective polarizer is configured to transmit a second polarization of light incident on the reflective polarizer.

Example 2. The apparatus of example 1, where the first polarization is a first handedness of circularly polarized light, the second polarization is a second handedness of circularly polarized light, and the reflective polarizer includes a chiral solid.

Example 3. The apparatus of any of examples 1 or 2, where the first polarization is a first direction of linearly polarized light, the second polarization is a second direction of linearly polarized light, and the first direction is orthogonal to the second direction.

Example 4. The apparatus of any of examples 1 - 3, where the reflective polarizer includes an optical multilayer film.

Example 5. The apparatus of any of examples 1 - 4, where the plurality of facets includes a central facet, and the reflective polarizer includes a central portion that conforms to the central facet.

Example 6. The apparatus of any of examples 1 - 5, where the plurality of facets further includes a ring-shaped facet, the reflective polarizer includes a ring-shaped portion that conforms to the ring-shaped facet, the central facet is a circular facet, and the ring-shaped facet encircles and is concentric with the central facet.

Example 7. The apparatus of any of examples 1 - 6, where the structured surface of the Fresnel lens includes steps located between neighboring facets of the plurality of facets, and the reflective polarizer does not cover the steps of the structured surface.

Example 8. The apparatus of any of examples 1 - 7, where each reflective polarizer portion of the plurality of reflective polarizer portions is attached to the corresponding facet of the plurality of facets using an adhesive layer.

Example 9. The apparatus of any of examples 1 - 8, where each reflective polarizer portion of the plurality of reflective polarizer portions is sized to match the corresponding facet of the plurality of facets.

Example 10. The apparatus of any of examples 1 - 9, where the Fresnel lens assembly further includes a filler polymer layer disposed over the reflective polarizer, and the filler polymer layer includes an optically transparent polymer.

Example 11. The apparatus of any of examples 1 - 10, where the reflective polarizer includes a first surface that conforms to the structured surface of the Fresnel lens, and a second surface that includes exterior facets and exterior steps.

Example 12. The apparatus of any of examples 1 - 11, where the apparatus further includes a display, and an optical configuration configured to provide an image of the display, where: the optical configuration includes the Fresnel lens assembly, the apparatus includes a head-mounted device, and the image of the display is viewable by a user of the apparatus when the user wears the head-mounted device.

Example 13. The apparatus of example 12, where the apparatus includes an augmented reality device or a virtual reality device.

Example 14. The apparatus of any of examples 12 or 13, where the optical configuration includes a folded optic configuration, and light from the display is both reflected by and transmitted through the Fresnel lens assembly as the light passes from the display through the optical configuration to form the image of the display at an eye of a user.

Example 15. The apparatus of any of examples 12 - 14, where the optical configuration further includes a beamsplitter lens, and an optical retarder.

Example 16. The apparatus of any of examples 12 - 15, where the display is configured to emit light having a circular polarization.

Example 17. A method including forming a reflective polarizer on a substrate, patterning the reflective polarizer to form reflective polarizer portions sized to match corresponding facets of a Fresnel lens, and applying the reflective polarizer portions to the corresponding facets of the Fresnel lens by urging the reflective polarizer portions against the corresponding facets of the Fresnel lens using a force applied to the substrate.

Example 18. The method of example 17, further including forming a filler layer conforming to the reflective polarizer portions, where the filler layer includes an optically transparent polymer.

Example 19. The method of any of examples 17 or 18, where forming the reflective polarizer on the substrate includes forming the reflective polarizer on an elastomer element.

Example 20. The method of any of examples 17 - 19, further including removing the substrate so that the reflective polarizer portions remain bonded to corresponding portions of the Fresnel lens, where the reflective polarizer is adhered to the substrate with a UV reversible adhesive or a thermally reversible adhesive, and removing the substrate includes UV irradiation or thermal debonding.

Embodiments of the present disclosure may include or be implemented in conjunction with various types of artificial reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial reality systems may be designed to work without near-eye displays (NEDs). Other artificial reality systems may include an NED that also provides visibility into the real world (such as, e.g., augmented-reality system 2100 in FIG. 21) or that visually immerses a user in an artificial reality (such as, e.g., virtual-reality system 2200 in FIG. 22). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 21, augmented-reality system 2100 may include an eyewear device 2102 with a frame 2110 configured to hold a left display device 2115(A) and a right display device 2115(B) in front of a user’s eyes. Display devices 2115(A) and 2115(B) may act together or independently to present an image or series of images to a user. While augmented-reality system 2100 includes two displays, embodiments of this disclosure may be implemented in augmented-reality systems with a single NED or more than two NEDs.

In some embodiments, augmented-reality system 2100 may include one or more sensors, such as sensor 2140. Sensor 2140 may generate measurement signals in response to motion of augmented-reality system 2100 and may be located on substantially any portion of frame 2110. Sensor 2140 may represent one or more of a variety of different sensing mechanisms, such as a position sensor, an inertial measurement unit (IMU), a depth camera assembly, a structured light emitter and/or detector, or any combination thereof. In some embodiments, augmented-reality system 2100 may or may not include sensor 2140 or may include more than one sensor. In embodiments in which sensor 2140 includes an IMU, the IMU may generate calibration data based on measurement signals from sensor 2140. Examples of sensor 2140 may include, without limitation, accelerometers, gyroscopes, magnetometers, other suitable types of sensors that detect motion, sensors used for error correction of the IMU, or some combination thereof.

In some examples, augmented-reality system 2100 may also include a microphone array with a plurality of acoustic transducers 2120(A)-2120(J), referred to collectively as acoustic transducers 2120. Acoustic transducers 2120 may represent transducers that detect air pressure variations induced by sound waves. Each acoustic transducer 2120 may be configured to detect sound and convert the detected sound into an electronic format (e.g., an analog or digital format). The microphone array in FIG. 21 may include, for example, ten acoustic transducers: 2120(A) and 2120(B), which may be designed to be placed inside a corresponding ear of the user, acoustic transducers 2120(C), 2120(D), 2120(E), 2120(F), 2120(G), and 2120(H), which may be positioned at various locations on frame 2110, and/or acoustic transducers 2120(I) and 2120(J), which may be positioned on a corresponding neckband 2105.

In some embodiments, one or more of acoustic transducers 2120(A)-(J) may be used as output transducers (e.g., speakers). For example, acoustic transducers 2120(A) and/or 2120(B) may be earbuds or any other suitable type of headphone or speaker.

The configuration of acoustic transducers 2120 of the microphone array may vary. While augmented-reality system 2100 is shown in FIG. 21 as having ten acoustic transducers 2120, the number of acoustic transducers 2120 may be greater or less than ten. In some embodiments, using higher numbers of acoustic transducers 2120 may increase the amount of audio information collected and/or the sensitivity and accuracy of the audio information. In contrast, using a lower number of acoustic transducers 2120 may decrease the computing power required by an associated controller 2150 to process the collected audio information. In addition, the position of each acoustic transducer 2120 of the microphone array may vary. For example, the position of an acoustic transducer 2120 may include a defined position on the user, a defined coordinate on frame 2110, an orientation associated with each acoustic transducer 2120, or some combination thereof.

Acoustic transducers 2120(A) and 2120(B) may be positioned on different parts of the user’s ear, such as behind the pinna, behind the tragus, and/or within the auricle or fossa. Or, there may be additional acoustic transducers 2120 on or surrounding the ear in addition to acoustic transducers 2120 inside the ear canal. Having an acoustic transducer 2120 positioned next to an ear canal of a user may enable the microphone array to collect information on how sounds arrive at the ear canal. By positioning at least two of acoustic transducers 2120 on either side of a user’s head (e.g., as binaural microphones), augmented-reality system 2100 may simulate binaural hearing and capture a 3D stereo sound field around about a user’s head. In some embodiments, acoustic transducers 2120(A) and 2120(B) may be connected to augmented-reality system 2100 via a wired connection 2130, and in other embodiments acoustic transducers 2120(A) and 2120(B) may be connected to augmented-reality system 2100 via a wireless connection (e.g., a BLUETOOTH connection). In still other embodiments, acoustic transducers 2120(A) and 2120(B) may not be used at all in conjunction with augmented-reality system 2100.

Acoustic transducers 2120 on frame 2110 may be positioned in a variety of different ways, including along the length of the temples, across the bridge, above or below display devices 2115(A) and 2115(B), or some combination thereof. Acoustic transducers 2120 may also be oriented such that the microphone array is able to detect sounds in a wide range of directions surrounding the user wearing the augmented-reality system 2100. In some embodiments, an optimization process may be performed during manufacturing of augmented-reality system 2100 to determine relative positioning of each acoustic transducer 2120 in the microphone array.

In some examples, augmented-reality system 2100 may include or be connected to an external device (e.g., a paired device), such as neckband 2105. Neckband 2105 generally represents any type or form of paired device. Thus, the discussion of neckband 2105 herein may also apply to various other paired devices, such as charging cases, smart watches, smart phones, wrist bands, other wearable devices, hand-held controllers, tablet computers, laptop computers, other external compute devices, etc.

As shown, neckband 2105 may be coupled to eyewear device 2102 via one or more connectors. The connectors may be wired or wireless and may include electrical and/or non-electrical (e.g., structural) components. In some cases, eyewear device 2102 and neckband 2105 may operate independently without any wired or wireless connection between them. While FIG. 21 illustrates the components of eyewear device 2102 and neckband 2105 in example locations on eyewear device 2102 and neckband 2105, the components may be located elsewhere and/or distributed differently on eyewear device 2102 and/or neckband 2105. In some embodiments, the components of eyewear device 2102 and neckband 2105 may be located on one or more additional peripheral devices paired with eyewear device 2102, neckband 2105, or some combination thereof.

Pairing external devices, such as neckband 2105, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 2100 may be provided by a paired device or shared between a paired device and an eyewear device, thus reducing the weight, heat profile, and form factor of the eyewear device overall while still retaining desired functionality. For example, neckband 2105 may allow components that would otherwise be included on an eyewear device to be included in neckband 2105 since users may tolerate a heavier weight load on their shoulders than they would tolerate on their heads. Neckband 2105 may also have a larger surface area over which to diffuse and disperse heat to the ambient environment. Thus, neckband 2105 may allow for greater battery and computation capacity than might otherwise have been possible on a standalone eyewear device. Since weight carried in neckband 2105 may be less invasive to a user than weight carried in eyewear device 2102, a user may tolerate wearing a lighter eyewear device and carrying or wearing the paired device for greater lengths of time than a user would tolerate wearing a heavy standalone eyewear device, thereby enabling users to more fully incorporate artificial reality environments into their day-to-day activities.

Neckband 2105 may be communicatively coupled with eyewear device 2102 and/or to other devices. These other devices may provide certain functions (e.g., tracking, localizing, depth mapping, processing, storage, etc.) to augmented-reality system 2100. In the embodiment of FIG. 21, neckband 2105 may include two acoustic transducers (e.g., 2120(I) and 2120(J)) that are part of the microphone array (or potentially form their own microphone subarray). Neckband 2105 may also include a controller 2125 and a power source 2135.

Acoustic transducers 2120(I) and 2120(J) of neckband 2105 may be configured to detect sound and convert the detected sound into an electronic format (analog or digital). In the embodiment of FIG. 21, acoustic transducers 2120(I) and 2120(J) may be positioned on neckband 2105, thereby increasing the distance between the neckband acoustic transducers 2120(I) and 2120(J) and other acoustic transducers 2120 positioned on eyewear device 2102. In some cases, increasing the distance between acoustic transducers 2120 of the microphone array may improve the accuracy of beamforming performed via the microphone array. For example, if a sound is detected by acoustic transducers 2120(C) and 2120(D) and the distance between acoustic transducers 2120(C) and 2120(D) is greater than, for example, the distance between acoustic transducers 2120(D) and 2120(E), the determined source location of the detected sound may be more accurate than if the sound had been detected by acoustic transducers 2120(D) and 2120(E).

Controller 2125 of neckband 2105 may process information generated by the sensors on neckband 2105 and/or augmented-reality system 2100. For example, controller 2125 may process information from the microphone array that describes sounds detected by the microphone array. For each detected sound, controller 2125 may perform a direction-of-arrival (DOA) estimation to estimate a direction from which the detected sound arrived at the microphone array. As the microphone array detects sounds, controller 2125 may populate an audio data set with the information. In embodiments in which augmented-reality system 2100 includes an inertial measurement unit, controller 2125 may compute all inertial and spatial calculations from the IMU located on eyewear device 2102. A connector may convey information between augmented-reality system 2100 and neckband 2105 and between augmented-reality system 2100 and controller 2125. The information may be in the form of optical data, electrical data, wireless data, or any other transmittable data form. Moving the processing of information generated by augmented-reality system 2100 to neckband 2105 may reduce weight and heat in eyewear device 2102, making it more comfortable for the user.

Power source 2135 in neckband 2105 may provide power to eyewear device 2102 and/or to neckband 2105. Power source 2135 may include, without limitation, lithium ion batteries, lithium-polymer batteries, primary lithium batteries, alkaline batteries, or any other form of power storage. In some cases, power source 2135 may be a wired power source. Including power source 2135 on neckband 2105 instead of on eyewear device 2102 may help better distribute the weight and heat generated by power source 2135.

As noted, some artificial reality systems may, instead of blending an artificial reality with actual reality, substantially replace one or more of a user’s sensory perceptions of the real world with a virtual experience. One example of this type of system is a head-worn display system, such as virtual-reality system 2200 in FIG. 22, that mostly or completely covers a user’s field of view. Virtual-reality system 2200 may include a front rigid body 2202 and a band 2204 shaped to fit around a user’s head. Virtual-reality system 2200 may also include output audio transducers 2206(A) and 2206(B). Furthermore, while not shown in FIG. 22, front rigid body 2202 may include one or more electronic elements, including one or more electronic displays, one or more inertial measurement units (IMUs), one or more tracking emitters or detectors, and/or any other suitable device or system for creating an artificial-reality experience.

Artificial reality systems may include a variety of types of visual feedback mechanisms. For example, display devices in augmented-reality system 2100 and/or virtual-reality system 2200 may include one or more liquid crystal displays (LCDs), light emitting diode (LED) displays, microLED displays, organic LED (OLED) displays, digital light projector (DLP) micro-displays, liquid crystal on silicon (LCoS) micro-displays, and/or any other suitable type of display screen. These artificial reality systems may include a single display screen for both eyes or may provide a display screen for each eye, which may allow for additional flexibility for varifocal adjustments or for correcting a user’s refractive error. Some of these artificial reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer’s eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial reality systems described herein may include one or more projection systems. For example, display devices in augmented-reality system 2100 and/or virtual-reality system 2200 may include micro-LED projectors that project light (using, e.g., a waveguide) into display devices, such as clear combiner lenses that allow ambient light to pass through. The display devices may refract the projected light toward a user’s pupil and may enable a user to simultaneously view both artificial reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial reality systems may also be configured with any other suitable type or form of image projection system, such as retinal projectors used in virtual retina displays.

The artificial reality systems described herein may also include various types of computer vision components and subsystems. For example, augmented-reality system 2100 and/or virtual-reality system 2200 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial reality system may process data from one or more of these sensors to identify a location of a user, to map the real world, to provide a user with context about real-world surroundings, and/or to perform a variety of other functions.

The artificial reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial reality systems described herein may also include tactile (i.e., haptic) feedback systems, which may be incorporated into headwear, gloves, bodysuits, handheld controllers, environmental devices (e.g., chairs, floor mats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial reality devices, within other artificial reality devices, and/or in conjunction with other artificial reality devices.

By providing haptic sensations, audible content, and/or visual content, artificial reality systems may create an entire virtual experience or enhance a user’s real-world experience in a variety of contexts and environments. For instance, artificial reality systems may assist or extend a user’s perception, memory, or cognition within a particular environment. Some systems may enhance a user’s interactions with other people in the real world or may enable more immersive interactions with other people in a virtual world. Artificial reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user’s artificial reality experience in one or more of these contexts and environments and/or in other contexts and environments.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive data to be transformed (e.g., eye-tracking sensor data), transform the data (e.g., into one or more of gaze direction, object viewed, or other vision parameter), output a result of the transformation to perform a function (e.g., modify an augmented reality environment, modify a real environment, modify an operational parameter of a real or virtual device, provide a control signal to an apparatus such as an electronic device, vehicle, or other apparatus), use the result of the transformation to perform a function, and store the result of the transformation to perform a function (e.g., in a memory device). Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Discs (CDs), Digital Video Disc (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein may be considered in all respects illustrative and not restrictive. Reference may be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. An apparatus comprising a Fresnel lens assembly, wherein the Fresnel lens assembly comprises:
a Fresnel lens; and
a reflective polarizer, wherein:
the Fresnel lens has a structured surface comprising a plurality of facets;
the reflective polarizer comprises a plurality of reflective polarizer portions;
each reflective polarizer portion of the plurality of reflective polarizer portions
conforms to a corresponding facet of the plurality of facets;
the reflective polarizer is configured to reflect a first polarization of light incident on the reflective polarizer; and
the reflective polarizer is configured to transmit a second polarization of light incident on the reflective polarizer.

2. The apparatus of claim 1, wherein:
the first polarization is a first handedness of circularly polarized light;
the second polarization is a second handedness of circularly polarized light; and
the reflective polarizer comprises a chiral solid.

3. The apparatus of claim 1, wherein:
the first polarization is a first direction of linearly polarized light;
the second polarization is a second direction of linearly polarized light; and
the first direction is orthogonal to the second direction.

4. The apparatus of claim 1, wherein the reflective polarizer comprises an optical multilayer film.

5. The apparatus of claim 1, wherein:
the plurality of facets comprises a central facet; and
the reflective polarizer comprises a central portion that conforms to the central facet.

6. The apparatus of claim 5, wherein:
the plurality of facets further comprises a ring-shaped facet;
the reflective polarizer comprises a ring-shaped portion that conforms to the ring-shaped facet;
the central facet is a circular facet; and
the ring-shaped facet encircles and is concentric with the central facet.

7. The apparatus of claim 1, wherein the structured surface of the Fresnel lens comprises steps located between neighboring facets of the plurality of facets; and
the reflective polarizer does not cover the steps of the structured surface.

8. The apparatus of claim 1, wherein each reflective polarizer portion of the plurality of reflective polarizer portions is attached to the corresponding facet of the plurality of facets using an adhesive layer.

9. The apparatus of claim 1, wherein each reflective polarizer portion of the plurality of reflective polarizer portions is sized to match the corresponding facet of the plurality of facets.

10. The apparatus of claim 1, wherein:
the Fresnel lens assembly further comprises a filler polymer layer disposed over the reflective polarizer; and
the filler polymer layer comprises an optically transparent polymer.

11. The apparatus of claim 1, wherein the reflective polarizer comprises:
a first surface that conforms to the structured surface of the Fresnel lens; and
a second surface that comprises exterior facets and exterior steps.

12. The apparatus of claim 1, wherein the apparatus further comprises:
a display; and
an optical configuration configured to provide an image of the display, wherein: the optical configuration comprises the Fresnel lens assembly;
the apparatus comprises a head-mounted device; and
the image of the display is viewable by a user of the apparatus when the user wears the head-mounted device.

13. The apparatus of claim 12, wherein the apparatus comprises an augmented reality device or a virtual reality device.

14. The apparatus of claim 12, wherein:
the optical configuration comprises a folded optic configuration; and
light from the display is both reflected by and transmitted through the Fresnel lens assembly as the light passes from the display through the optical configuration to form the image of the display at an eye of a user.

15. The apparatus of claim 12, wherein the optical configuration further comprises:
a beamsplitter lens; and
an optical retarder.

16. The apparatus of claim 12, wherein the display is configured to emit light having a circular polarization.

17. A method comprising:
forming a reflective polarizer on a substrate;
patterning the reflective polarizer to form reflective polarizer portions sized to match corresponding facets of a Fresnel lens; and
applying the reflective polarizer portions to the corresponding facets of the Fresnel lens by urging the reflective polarizer portions against the corresponding facets of the Fresnel lens using a force applied to the substrate.

18. The method of claim 17, further comprising forming a filler layer conforming to the reflective polarizer portions, wherein:
the filler layer comprises an optically transparent polymer.

19. The method of claim 17, wherein forming the reflective polarizer on the substrate comprises forming the reflective polarizer on an elastomer element.

20. The method of claim 17, further comprising removing the substrate so that the reflective polarizer portions remain bonded to corresponding portions of the Fresnel lens, wherein:
the reflective polarizer is adhered to the substrate with a UV reversible adhesive or a thermally reversible adhesive; and
removing the substrate comprises UV irradiation or thermal debonding.
